(19) United States
(12) Patent Application Publication
(10) Pub. No.: US 2025/0141317 A1
(43) Pub. Date: May 1, 2025

(54) ELECTRIC WORK MACHINE

(71) Applicant: MAKITA CORPORATION, Anjo-shi (JP)

(72) Inventor: Fuminari FUJII, Anjo-shi (JP)

(73) Assignee: MAKITA CORPORATION, Anjo-shi (JP)

(21) Appl. No.: 18/906,686

(22) Filed: Oct. 4, 2024

(30) Foreign Application Priority Data
Oct. 25, 2023 (JP) 2023-183562
Apr. 17, 2024 (JP) 2024-066799

(51) Int. Cl. H02K 11/215; B25F 5/00; H02K 7/14; H02K 9/06; H02K 11/33; H02K 21/16

(52) U.S. Cl. CPC H02K 11/215; H02K 7/145; H02K 9/06; H02K 11/33; H02K 21/16; B25F 5/001; B25F 5/008; H02K 2211/03

(57) ABSTRACT

An electric work machine includes: a motor including a rotor that rotates about a rotation axis and a stator disposed around the rotor; and a sensor substrate including a rotation sensor that detects rotation of the rotor and a plate that supports the rotation sensor. The stator includes: a stator core disposed around the rotor; an insulator fixed to the stator core; and a plurality of coils fixed to the insulator and arranged at intervals in a circumferential direction. The plate includes: an arc portion extending partially around the rotation axis and having a first surface facing an end surface of the rotor in an axial direction, and at least two arm portions protruding outward in a radial direction from the arc portion and fixed to the insulator. The rotation sensor is disposed on the first surface.

### CROSS-REFERENCE TO RELATED APPLICATION(S)

The present application claims priority to and incorporates by reference the entire contents of Japanese Patent Application No. 2023-183562 filed in Japan on Oct. 25, 2023 and Japanese Patent Application No. 2024-066799 filed in Japan on Apr. 17, 2024.

### TECHNICAL FIELD

The present disclosure relates to an electric work machine.

### BACKGROUND ART

In a technical field related to an electric work machine, an electric work machine including a motor and a sensor substrate as disclosed in JP 2022-012822 A is known.

An increase in the size of an electric work machine may make it difficult for a worker who uses the electric work machine to smoothly use the electric work machine. Therefore, reduction of the size and weight of the electric work machine is required. When the electric work machine includes a sensor substrate, size and weight reduction of the sensor substrate contributes to size and weight reduction of the electric work machine.

### SUMMARY

One non-limiting object of techniques disclosed in the present disclosure is to reduce the size and weight of the sensor substrate of the electric work machine.

In one non-limiting aspect of the present disclosure, an electric work machine may include: a motor including a rotor that rotates about a rotation axis and a stator disposed around the rotor; and a sensor substrate including a rotation sensor that detects rotation of the rotor and a plate that supports the rotation sensor. The stator includes: a stator core disposed around the rotor; an insulator fixed to the stator core; and a plurality of coils fixed to the insulator and arranged at intervals in a circumferential direction. The plate includes: an arc portion extending partially around the rotation axis and having a first surface facing an end surface of the rotor in an axial direction, and at least two arm portions protruding outward in a radial direction from the arc portion and fixed to the insulator. The rotation sensor is disposed on the first surface.

According to the techniques disclosed in the present disclosure, it is possible to reduce the size and weight of the sensor substrate of the electric work machine.

### BRIEF DESCRIPTION OF THE DRAWINGS

FIG. 1 is a side view of an electric work machine according to a first embodiment;

FIG. 2 is an exploded front perspective view of a motor assembly according to the first embodiment;

FIG. 3 is a rear perspective view of a stator and a sensor substrate according to the first embodiment;

FIG. 4 is a front view of the stator and the sensor substrate according to the first embodiment;

FIG. 5 is a front view of the stator according to the first embodiment;

FIG. 6 is a rear view of the stator and the sensor substrate according to the first embodiment;

FIG. 7 is a left side view of the stator and the sensor substrate according to the first embodiment;

FIG. 8 is a cross-sectional view of the stator and the sensor substrate according to the first embodiment;

FIG. 9 is an exploded front perspective view of the stator and the sensor substrate according to the first embodiment;

FIG. 10 is a front view of a stator and a sensor substrate according to a second embodiment;

FIG. 11 is a front view of the stator according to a second embodiment;

FIG. 12 is a left side view of the stator and the sensor substrate according to the second embodiment;

FIG. 13 is a cross-sectional view of the stator and the sensor substrate according to the second embodiment;

FIG. 14 is a front view of a stator and a sensor substrate according to a third embodiment;

FIG. 15 is a front view of the stator according to the third embodiment;

FIG. 16 is a left side view of the stator and the sensor substrate according to the third embodiment;

FIG. 17 is a cross-sectional view of the stator and the sensor substrate according to the third embodiment;

FIG. 18 is an exploded front perspective view of the stator and the sensor substrate according to the third embodiment;

FIG. 19 is a cross-sectional view of the stator and the sensor substrate according to the third embodiment;

FIG. 20 is a front view of a stator and a sensor substrate according to a fourth embodiment;

FIG. 21 is a front view of the stator according to the fourth embodiment;

FIG. 22 is a left side view of the stator and the sensor substrate according to the fourth embodiment;

FIG. 23 is a cross-sectional view of a stator and the sensor substrate according to the fourth embodiment;

FIG. 24 is a front view of a stator and a sensor substrate according to a fifth embodiment;

FIG. 25 is a left side view of the stator and the sensor substrate according to the fifth embodiment;

FIG. 26 is a cross-sectional view of the stator and the sensor substrate according to the fifth embodiment;

FIG. 27 is a front view of a stator and a sensor substrate according to a sixth embodiment;

FIG. 28 is a left side view of the stator and the sensor substrate according to the sixth embodiment;

FIG. 29 is a cross-sectional view of the stator and the sensor substrate according to the sixth embodiment;

FIG. 30 is a front view of a stator and a sensor substrate according to a seventh embodiment;

FIG. 31 is a left side view of the stator and the sensor substrate according to the seventh embodiment;

FIG. 32 is a cross-sectional view of the stator and the sensor substrate according to the seventh embodiment;

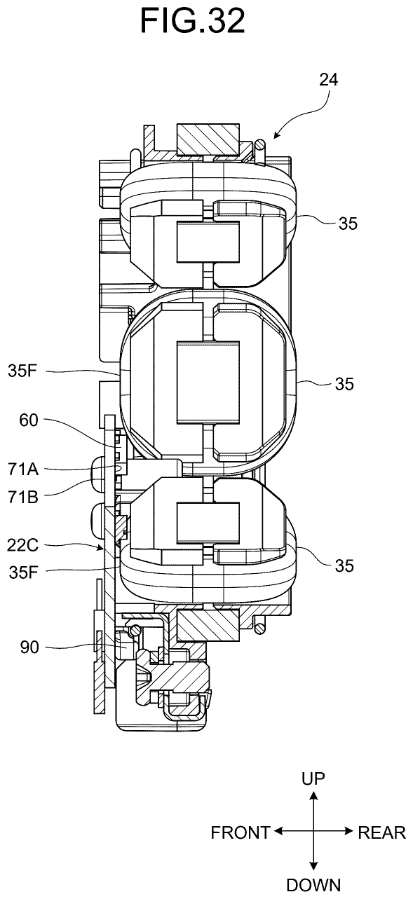

FIG. 33 is a front view of a stator and a sensor substrate according to an eighth embodiment;

FIG. 34 is a left side view of the stator and the sensor substrate according to the eighth embodiment;

FIG. 35 is a cross-sectional view of the stator and the sensor substrate according to the eighth embodiment;

FIG. 36 is a front view of a stator and a sensor substrate according to a ninth embodiment;

FIG. 37 is a diagram illustrating a relationship of an first surface and a second surface to a front end of a coil according to a tenth embodiment;

FIG. 38 is a front view of a stator and a sensor substrate according to an eleventh embodiment;

FIG. 39 is an exploded front perspective view of the stator and the sensor substrate according to the eleventh embodiment;

FIG. 40 is a cross-sectional view of the stator and the sensor substrate according to the eleventh embodiment; and

FIG. 41 is a perspective view of a portion covered with a cover of the sensor substrate according to the eleventh embodiment.

### DETAILED DESCRIPTION

In one or more embodiments, an electric work machine may include a motor having a rotor that rotates about a rotation axis and a stator disposed around the rotor, and a sensor substrate having a rotation sensor that detects rotation of the rotor and a plate that supports the rotation sensor. The stator may include a stator core disposed around the rotor, an insulator fixed to the stator core, and a plurality of coils fixed to the insulator and disposed at intervals in a circumferential direction. The plate may include an arc portion extending partially around the rotation axis and having an first surface facing an end surface of the rotor in an axial direction, and at least two arm portions protruding outward in a radial direction from the arc portion and fixed to the insulator. The rotation sensor may be disposed on the first surface.

In the above configuration, since a part of the plate of the sensor substrate is the arc portion, the sensor substrate is reduced in size and weight. Since a part of the plate fixed to the insulator is the arm portions, the sensor substrate is reduced in size and weight. As the sensor substrate is reduced in size and weight, a motor assembly including the motor and the sensor substrate is reduced in size and weight. As a result, the electric work machine is reduced in size and weight. In addition, many plates are manufactured from one rectangular printed wiring board (PWB).

In one or more embodiments, the arc portion may be disposed radially inside the coil.

In the above configuration, the motor assembly is downsized in the radial direction.

In one or more embodiments, a radially outer end of the arm portion may be positioned radially outside the coil. The end of the arm portion may be fixed to the insulator.

In the above configuration, the sensor substrate is fixed to the insulator by fixing the end of the arm portion to the insulator.

In one or more embodiments, in the axial direction, the first surface may be positioned closer to a center of the coil than one end of the coil.

In the above configuration, since at least a part of the arc portion is positioned radially inside the coil, the motor assembly is downsized in the axial direction.

In one or more embodiments, the arc portion may have a second surface that faces in a direction opposite to a direction in which the first surface faces. In the axial direction, the second surface may be disposed at a position closer to the center of the coil than the one end of the coil.

In the above configuration, since the entire arc portion is positioned radially inside the coil, the motor assembly is downsized in the axial direction.

In one or more embodiments, the plate may be a parallel flat plate.

In the above configuration, the plate is manufactured from a printed wiring board (PWB).

In one or more embodiments, each of the arm portions may be disposed between a pair of the coils adjacent to each other.

In the above configuration, even when the plate is a parallel flat plate, at least a part of the arc portion is positioned radially inside the coil.

In one or more embodiments, the arm portions may include a first arm portion and a second arm portion. The first arm portion may protrude outward in the radial direction from the one end of the arc portion in the circumferential direction, and the second arm portion may protrude outward in the radial direction from the other end of the arc portion in the circumferential direction.

In the above configuration, bending or vibration at the end of the arc portion in the circumferential direction is suppressed.

In one or more embodiments, the plate may include a bridge portion connecting a radially outer end of the first arm portion and a radially outer end of the second arm portion.

In the above configuration, a strength of the plate is improved.

In one or more embodiments, the bridge portion may have an arc shape extending partially around the rotation axis.

In the above configuration, an increase in size of the motor assembly in the radial direction is suppressed.

In one or more embodiments, the electric work machine may include a controller that controls a drive current supplied to the coils based on a detection signal of the rotation sensor, and a signal line that connects the rotation sensor and the controller. The signal line may be supported by the bridge portion.

In the above configuration, the signal line is supported by the bridge portion of the plate.

In one or more embodiments, the arm portions may include a third arm portion. The third arm portion may protrude outward in the radial direction from a center of the arc portion in the circumferential direction.

In the above configuration, the sensor substrate is sufficiently fixed to the insulator by fixing each of the first arm portion, the second arm portion, and the third arm portion to the insulator.

In one or more embodiments, the electric work machine may include the controller that controls the drive current supplied to the coils based on the detection signal of the rotation sensor, and the signal line that connects the rotation sensor and the controller. The signal line may be supported by the third arm portion.

In the above configuration, the signal line is supported by the third arm portion of the plate.

In one or more embodiments, the electric work machine may include a power supply terminal through which the drive current flows. In a plane orthogonal to the rotation axis, the third arm portion may be disposed so as to overlap the power supply terminal.

In the above configuration, an increase in size of the motor assembly in the radial direction is suppressed.

In one or more embodiments, at least one of the first arm portion, the second arm portion, and the third arm portion may be fixed to the insulator with a screw.

In the above configuration, the sensor substrate can be easily replaced with a new sensor substrate by unscrewing.

In one or more embodiments, the plate may include a cover portion connecting the radially outer end of the first arm portion, the radially outer end of the second arm portion, and the radially outer end of the third arm portion.

In the above configuration, a strength of the plate is improved.

In one or more embodiments, the electric work machine may include the controller that controls the drive current supplied to the coils based on the detection signal of the rotation sensor, and the signal line that connects the rotation sensor and the controller. The signal line may be supported on the cover portion.

In the above configuration, the signal line is supported on the cover portion of the plate.

In one or more embodiments, the electric work machine may include the power supply terminal through which the drive current flows. In the plane orthogonal to the rotation axis, the cover portion may be disposed so as to overlap the power supply terminal.

In the above configuration, an increase in size of the motor assembly in the radial direction is suppressed.

In one or more embodiments, the electric work machine may include a support member that is fixed to the insulator. At least two arm portions may be fixed to the insulator via the support member.

In the above configuration, the plate is fixed to the insulator via the support member. Even when the plate is the parallel flat plate, the plate and the insulator are appropriately fixed to each other via the support member by adjusting the shape of the support member.

In one or more embodiments, the support member may include: a support arc portion fixed to the insulator by a first screw; and a screw boss, which is disposed radially inside the support arc portion and to which the arm portion is fixed by a second screw. In the axial direction, an end surface of the screw boss facing in the same direction as the first surface may be disposed at a position closer to the center of the coil than the end surface of the stator core facing in a direction opposite to the direction in which the first surface faces.

In the above configuration, the plate is stably fixed to the insulator via the support member. Since the screw boss is disposed radially inside the support arc portion, a length of the screw boss is not restricted. In a case where the plate is disposed at a position closer to the center of the coil than the one end of the coil, when the plate is fixed to the insulator by the second screw, a leading end of the second screw may hit the end surface of the stator core when the second screw is long. Therefore, there is a possibility that it is necessary to shorten the second screw. When the second screw is short, there is a possibility that fixing between the plate and the insulator becomes unstable. In the present embodiment, since the length of the screw boss is not restricted, a long second screw can be used even when the plate is disposed at a position closer to the center of the coil than the one end of the coil. Therefore, the plate is stably fixed to the insulator via the support member.

Hereinafter, embodiments according to the present disclosure will be described with reference to the drawings. However, the present disclosure is not limited to the embodiments. Components of the embodiments described below can be appropriately combined. In addition, some components may not be used.

In the embodiments, positional relationships among parts will be described using terms of “left”, “right”, “front”, “rear”, “up”, and “down”. These terms indicate relative positions or directions with respect to the center of the electric work machine.

The electric work machine includes the motor. In the embodiments, a direction parallel to a rotation axis AX of the motor is referred to as an axial direction as appropriate. A radiation direction of the rotation axis AX of the motor is referred to as a radial direction as appropriate. A direction around the rotation axis AX of the motor is referred to as a circumferential direction or a rotation direction as appropriate.

A position on one way or a direction in one way in the axial direction is referred to as one axial direction, as appropriate, and a position in the other way or a direction in the other way in the axial direction is referred to as the other axial direction as appropriate. In the embodiment, the rotation axis AX of the motor extends in a front-rear direction. The axial direction and the front-rear direction are parallel. The one axial direction is forward, and the other axial direction is rearward.

In the radial direction, a position close to or a direction approaching the rotation axis AX of the motor is referred to as radially inside as appropriate, and a position far from or a direction away from the rotation axis AX of the motor is referred to as radially outside as appropriate.

A position in one way or a direction in one way in the circumferential direction is referred to as one circumferential direction as appropriate, and a position in the other way or a direction in the other side in the circumferential direction is referred to as the other circumferential direction as appropriate. The one circumferential direction is a forward rotation side, and the other the circumferential direction is a reverse rotation side.

### First Embodiment

### Electric Work Machine

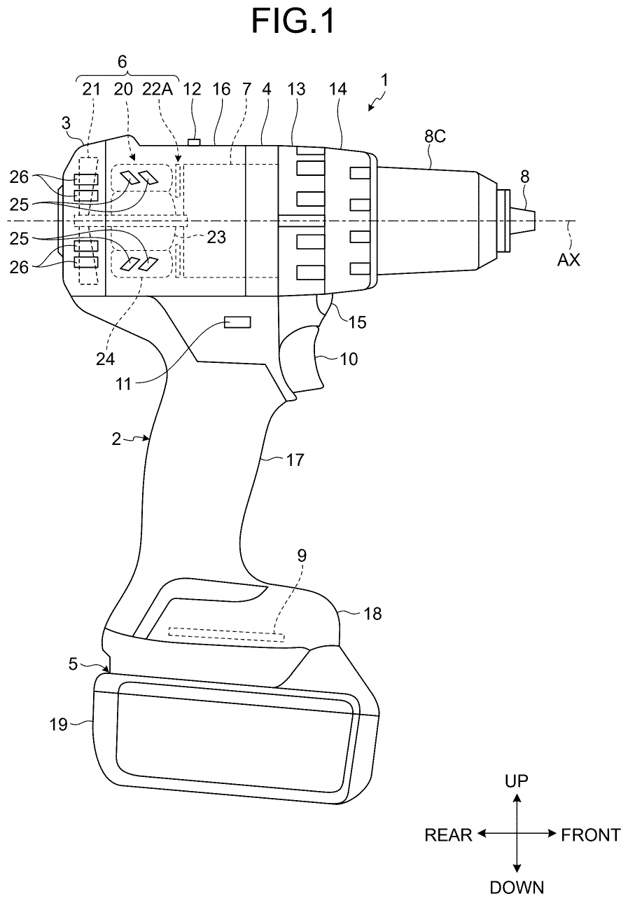

A first embodiment will be described. FIG. 1 is a side view of an electric work machine 1 according to the present embodiment. In the present embodiment, the electric work machine 1 is a hammer driver drill that is a kind of electric tool. As illustrated in FIG. 1, the electric work machine 1 includes a housing 2, a rear cover 3, a gear case 4, a battery mounting portion 5, a motor assembly 6, a power transmission mechanism 7, a spindle 8, a controller 9, a trigger switch 10, a forward/reverse changing lever 11, a speed changing lever 12, a mode change ring 13, a change ring 14, and a light 15.

The housing 2 includes a motor housing 16, a grip 17, and a controller housing 18. The housing 2 is made of synthetic resin.

The motor housing 16 houses at least a part of the motor assembly 6. The motor housing 16 has a cylindrical shape.

The grip 17 is gripped by an operator who uses the electric work machine 1. The grip 17 protrudes downward from a lower portion of the motor housing 16.

The controller housing 18 houses the controller 9. The controller housing 18 is connected to a lower end of the grip 17. In each of the front-rear direction and a left-right direction, an outer dimension of the controller housing 18 is larger than an outer dimension of the grip 17.

The rear cover 3 is connected to a rear portion of the motor housing 16 so as to cover an opening in the rear portion of the motor housing 16. The rear cover 3 is made of synthetic resin.

The gear case 4 is connected to the front of the motor housing 16. The gear case 4 accommodates at least a part of the power transmission mechanism 7. The gear case 4 has a cylindrical shape. The gear case 4 is made of metal.

The battery mounting portion 5 is provided on a lower portion of the controller housing 18 of the housing 2. A battery pack 19 is mountable on the battery mounting portion 5. The battery pack 19 is detachable from the battery mounting portion 5. The battery pack 19 includes a secondary battery. In the present embodiment, the battery pack 19 includes a rechargeable lithium ion battery. The battery pack 19 functions as a power supply unit of the electric work machine 1. The battery pack 19 can supply electric power to the electric work machine 1 by being mounted on the battery mounting portion 5.

The motor assembly 6 includes a motor 20, a fan 21, and a sensor substrate 22A. The motor 20 is a power source of the electric work machine 1. The motor 20 includes a rotor 23 and a stator 24. The rotor 23 rotates about the rotation axis AX. The fan 21 generates an air flow for cooling the motor 20. The fan 21 is rotated by a rotational force generated by the motor 20. The sensor substrate 22A detects the rotation of the rotor 23. Detection signals of the sensor substrate 22A is output to the controller 9.

The motor housing 16 has air-intake ports 25. The rear cover 3 has air-exhaust ports 26. The air-exhaust ports 26 are provided rearward of the air-intake ports 25. The intake ports 25 connect an internal space and an external space of the housing 2. The air-exhaust ports 26 connect the internal space and the external space of the housing 2. The air-intake ports 25 are provided on both a left part and a right part of the motor housing 16. The air-exhaust ports 26 are provided on both left and right of the rear cover 3. When the fan 21 rotates, air in the external space of the housing 2 flows into the internal space of the housing 2 via the air-intake ports 25. The air flowing into the internal space of the housing 2 cools the motor 20. The air in the internal space of the housing 2 flows out to the external space of the housing 2 via the air-exhaust ports 26.

The power transmission mechanism 7 transmits the rotational force generated by the motor 20 to the spindle 8. The power transmission mechanism 7 includes a plurality of gears.

The spindle 8 rotates based on the rotational force of the motor 20 transmitted by the power transmission mechanism 7. The spindle 8 rotates about the rotation axis AX. The spindle 8 has an insertion hole into which an tool accessory is inserted. A chuck mechanism 8C that holds the tool accessory is provided at least partially around the spindle 8. The tool accessory is held by the chuck mechanism 8C while being inserted into the insertion hole of the spindle 8.

The controller 9 controls the motor 20. The controller 9 controls the drive current supplied from the battery pack 19 to the motor 20 based on the detection signals of the sensor substrate 22A. The controller 9 is housed in the controller housing 18. The controller 9 includes a substrate on which a plurality of electronic components is mounted. Examples of the electronic components mounted on the substrate include a processor such as a central processing unit (CPU), a nonvolatile memory such as a read only memory (ROM) or a storage, a volatile memory such as a random access memory (RAM), a field effect transistor (FET), and a resistor.

The trigger switch 10 is operated by an operator to drive the motor 20. The trigger switch 10 is provided on an upper portion of the grip 17. The trigger switch 10 protrudes forward from an upper front portion of the grip 17. The trigger switch 10 is moved backward by the operator. The operator can move the trigger switch 10 backward by, for example, an index finger. The trigger switch 10 is operated by the operator to generate an operation signal. The operation signal of the trigger switch 10 is input to the controller 9. The controller 9 drives the motor 20 based on the operation signal of the trigger switch 10. When the operation of the trigger switch 10 is released, the motor 20 stops. The operator can stop the motor 20 by, for example, stopping the backward movement of the trigger switch 10 by the index finger.

The forward/reverse changing lever 11 is operated by the operator to change the rotation direction of the motor 20 from one of the forward rotation direction and the reverse rotation direction to the other. The forward/reverse changing lever 11 is provided at a boundary between a lower end of the motor housing 16 and an upper end of the grip 17. The forward/reverse changing lever 11 is moved leftward or rightward by the operator. The forward/reverse changing lever 11 is moved leftward or rightward to change the rotation direction of the motor 20. The rotation direction of the spindle 8 is changed by changing the rotation direction of the motor 20.

The speed changing lever 12 is operated by the operator to change the rotation speed of the spindle 8 from one of a first speed and a second speed to the other. The speed changing lever 12 is provided on an upper portion of the motor housing 16. The speed changing lever 12 is moved forward or backward by the operator. When the speed changing lever 12 is moved forward or backward, the rotation speed of the motor 20 is changed.

The mode change ring 13 is operated by the operator to change a work mode of the electric work machine 1. The mode change ring 13 is forward of the gear case 4. The mode change ring 13 is rotated by the operator. The work mode of the electric work machine 1 includes a hammer mode in which the spindle 8 hammers in the axial direction and a non-hammer mode in which the spindle 8 does not hammer in the axial direction. The non-vibration mode includes a drill mode in which power is transmitted to the spindle 8 regardless of a rotational load acting on the spindle 8, and a clutch mode in which the power transmitted to the spindle 8 is cut off based on the rotational load acting on the spindle 8.

The change ring 14 is operated by the operator to set a release value, at which the power transmitted to the spindle 8 is cut off. The change ring 14 is disposed forward of the mode change ring 13. The change ring 14 is rotated by the operator. The release value is a value related to the rotational load acting on the spindle 8. When the rotational load acting on the spindle 8 has reached the release value, the power transmitted to the spindle 8 is cut off.

The light 15 emits illumination light, which illuminates forward of the electric work machine 1. The light 15 includes a light emitting diode (LED). The light 15 is provided at the upper front portion of the grip 17.

### Motor Assembly

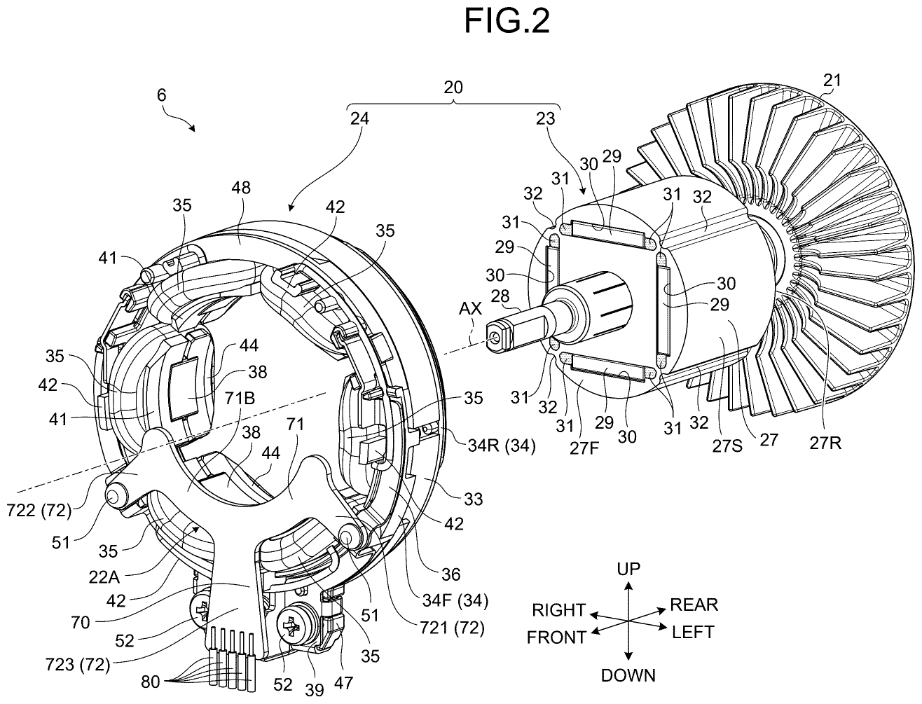

FIG. 2 is a front exploded perspective view of the motor assembly 6 according to the present embodiment. The motor assembly 6 includes the motor 20, the fan 21, and the sensor substrate 22A.

The motor 20 is driven by electric power supplied from the battery pack 19. The motor 20 generates the rotational force for rotating the spindle 8.

The motor 20 includes the rotor 23 and the stator 24. The rotor 23 rotates with respect to the stator 24. In the present embodiment, the motor 20 is an inner rotor type brushless motor. The stator 24 is disposed around the rotor 23. The rotor 23 rotates about the rotation axis AX.

The rotor 23 includes a rotor core 27, a rotor shaft 28, and permanent magnets 29.

The rotor core 27 includes a plurality of stacked steel plates. The steel plate is a metal plate containing iron as a main component. The rotor core 27 is disposed so as to surround the rotation axis AX. The rotor core 27 has an end surface 27F facing forward, an end surface 27R facing rearward, and an outer surface 27S facing radially outward.

The rotor shaft 28 extends in the axial direction. The rotor shaft 28 is disposed inside the rotor core 27. The rotor core 27 and the rotor shaft 28 are fixed. A front portion of the rotor shaft 28 protrudes forward from the end surface 27F of the rotor core 27. A rear portion of the rotor shaft 28 protrudes rearward from the end surface 27R of the rotor core 27. The front portion of the rotor shaft 28 is rotatably supported by a front bearing (not illustrated). The rear portion of the rotor shaft 28 is rotatably supported by a rear bearing (not illustrated). A front end of the rotor shaft 28 is connected to the power transmission mechanism 7.

The permanent magnets 29 are supported by the rotor core 27. In the present embodiment, four of the permanent magnets 29 are disposed around the rotation axis AX. The rotor core 27 and the permanent magnets 29 are fixed. As the permanent magnet 29, a neodymium-iron-boron magnet is exemplified. The permanent magnets 29 each has a plate shape. The permanent magnets 29 are disposed inside the rotor core 27. The motor 20 is an interior permanent magnet (IPM) motor. The rotor core 27 has magnet holes 30. The magnet holes 30 each extend in the axial direction. The permanent magnets 29 are respectively disposed in the magnet holes 30. A gap between the outer surface of each of the permanent magnets 29 and the inner surface of each of the magnet holes 30 is filled with the resin 31.

Recesses 32 are formed in the outer surface 27S of the rotor core 27. The recesses 32 each extend in the axial direction. A front end of each of the recesses 32 is connected to the end surface 27F of the rotor core 27. The rear end of each of the recess 32 is connected to the end surface 27R of the rotor core 27. The recesses 32 are provided on the outer surface 27S of the rotor core 27. In the present embodiment, four of the recesses 32 are provided around the rotation axis AX. The recesses 32 are arranged at equal intervals in the circumferential direction. The recesses 32 are provided to suppress generation of noise due to rotation of the rotor core 27. The recesses 32 may be omitted.

The fan 21 generates an air flow for cooling the motor 20. The fan 21 is disposed rearward of the stator 24 and the rotor core 27. The fan 21 is fixed to the rear portion of the rotor shaft 28. At least a part of the fan 21 is disposed at a position facing the end surface 27R of the rotor core 27. The fan 21 is rotated by the rotational force generated by the motor 20. When the rotor shaft 28 rotates, the fan 21 rotates together with the rotor shaft 28.

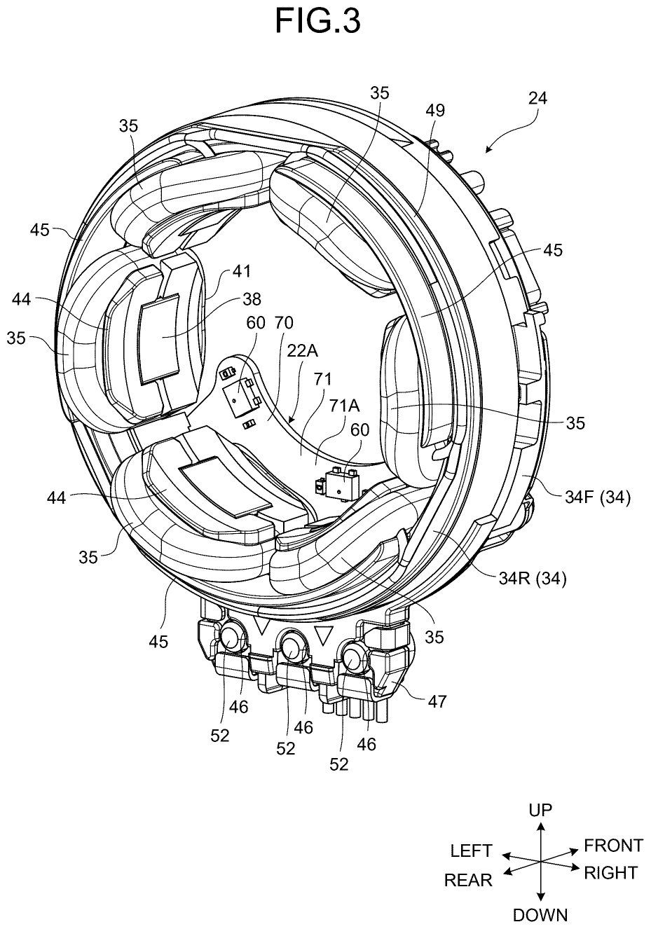

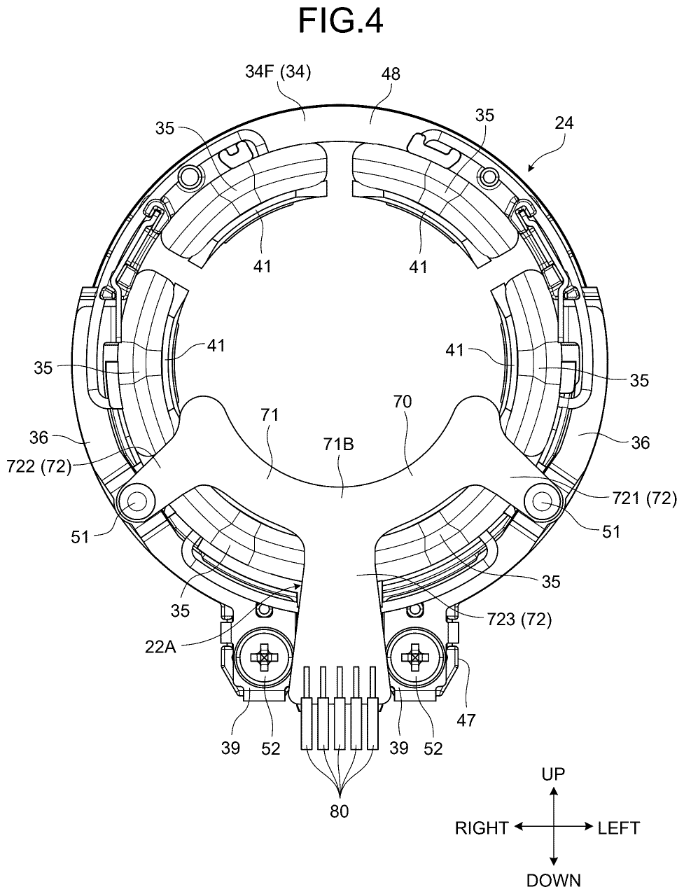

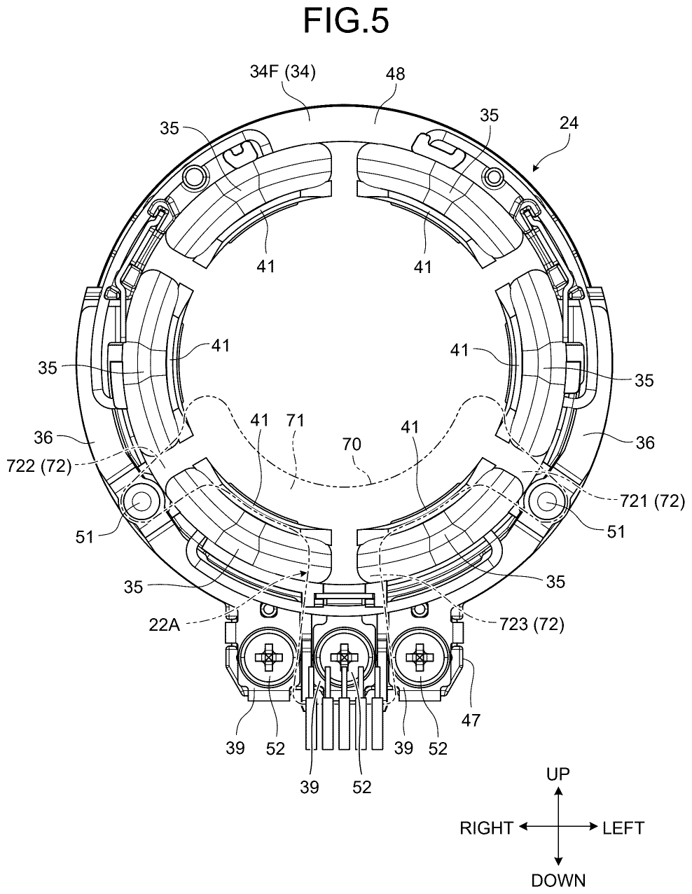

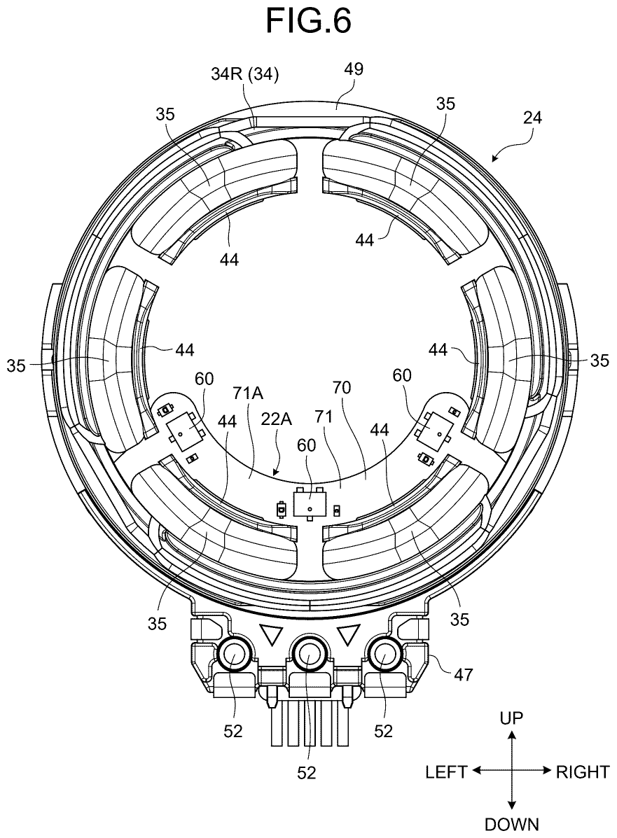

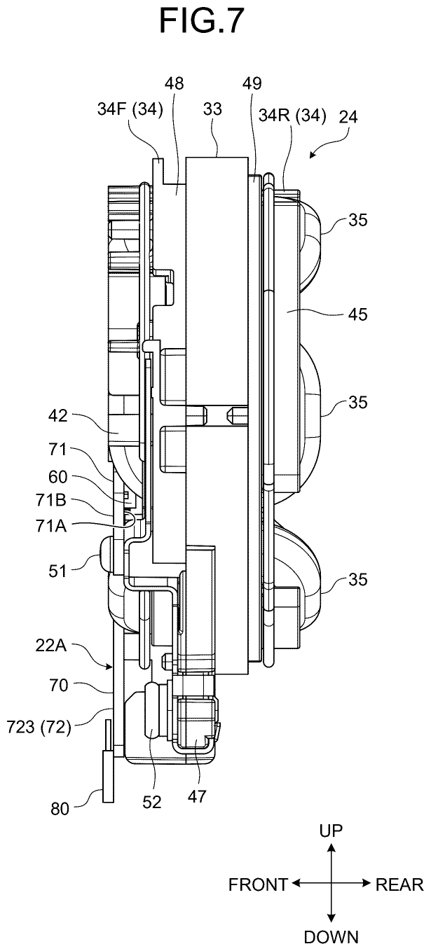

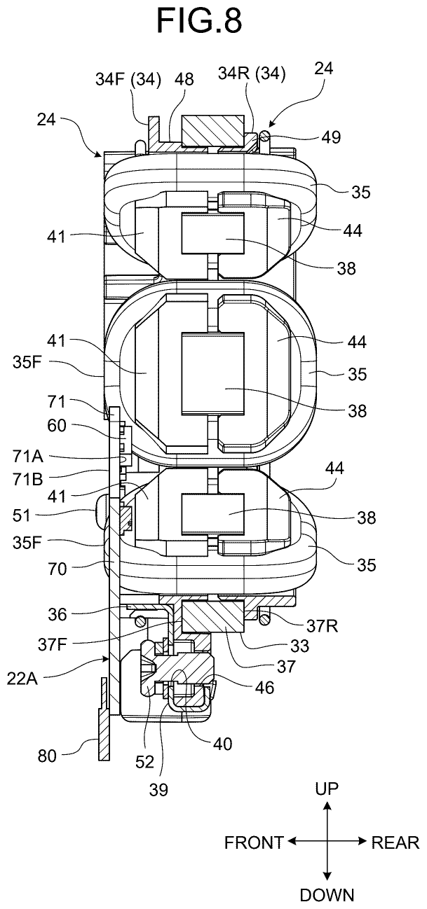

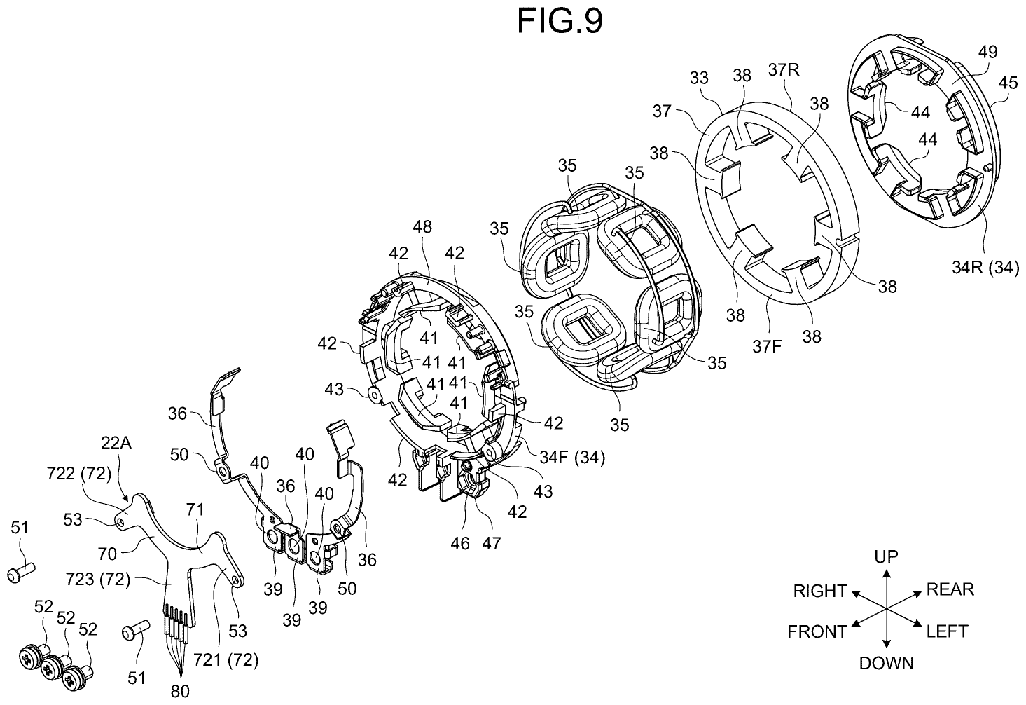

FIG. 3 is a rear perspective view of the stator 24 and the sensor substrate 22A according to the present embodiment. FIG. 4 is a front view of the stator 24 and the sensor substrate 22A according to the present embodiment. FIG. 5 is a front view of the stator 24 according to the present embodiment. In FIG. 5, the sensor substrate 22A is indicated by a virtual line. FIG. 6 is a rear view of the stator 24 and the sensor substrate 22A according to the present embodiment. FIG. 7 is a left side view of the stator 24 and the sensor substrate 22A according to the present embodiment. FIG. 8 is a cross-sectional view of the stator 24 and the sensor substrate 22A according to the present embodiment. FIG. 9 is an exploded front perspective view of the stator 24 and the sensor substrate 22A according to the present embodiment.

As illustrated in FIGS. 2, 3, 4, 5, 6, 7, 8, and 9, the stator 24 includes a stator core 33, an insulator 34, coils 35, and short-circuiting members 36.

The stator core 33 includes a plurality of stacked steel plates. Each of the steel plates is a metal plate containing iron as a main component. The stator core 33 is disposed around the rotor core 27 of the rotor 23.

The stator core 33 includes a yoke 37 and teeth 38. The yoke 37 is disposed so as to surround the rotation axis AX. The yoke 37 has a cylindrical shape. The teeth 38 protrude radially inward from an inner peripheral surface of the yoke 37. The teeth 38 are provided in the circumferential direction. In the present embodiment, six of the teeth 38 are provided. The teeth 38 are arranged at intervals in the circumferential direction.

The insulator 34 is an electrical insulating member made of synthetic resin. The insulator 34 is fixed to the stator core 33. The insulator 34 is disposed so as to cover at least a part of a surface of the stator core 33. In the present embodiment, the insulator 34 includes a front insulator 34F fixed to a front portion of the stator core 33 and a rear insulator 34R fixed to a rear portion of the stator core 33. The front insulator 34F is disposed so as to cover an end surface 37F of the yoke 37 facing forward and a front surface of the teeth 38. The rear insulator 34R is disposed so as to cover an end surface 37R of the yoke 37 facing rearward and a rear surface of the teeth 38.

The coils 35 are fixed to the insulator 34. The coils 35 are respectively wound around the teeth 38 via the insulator 34. The coils 35 are provided at intervals in the circumferential direction. In the present embodiment, six of the coils 35 are provided.

The front insulator 34F includes an annular portion 48 and a terminal support 47 protruding downward from a lower part of the annular portion 48. The annular portion 48 is provided with inner coil stoppers 41, outer coil stoppers 42, and screw bosses 43. Screw holes 46 are provided in the terminal support 47. The rear insulator 34R has an annular portion 49. The annular portion 49 is provided with inner coil stoppers 44 and outer coil stoppers 45.

The annular portion 48 is disposed so as to cover the end surface 37F of the yoke 37. The inner coil stoppers 41 are connected to the annular portion 48. The inner coil stoppers 41 are disposed radially inside the coil 35. The inner coil stoppers 41 support the coils 35 from radially inside. The outer coil stoppers 42 protrude forward from the annular portion 48. The outer coil stoppers 42 are disposed radially outside the coils 35. The outer coil stoppers 42 support the coils 35 from radially outside.

The screw bosses 43 each has a screw hole. The screw bosses 43 each protrude forward from the annular portion 48. Two of the screw bosses 43 are provided. One screw boss 43 is provided in lower left of the annular portion 48. The other screw boss 43 is provided in lower right of the annular portion 48. The screw holes 46 are provided in the terminal support 47. Three of the screw holes 46 are provided. The three screw holes 46 are arranged in the left-right direction.

The annular portion 49 is disposed so as to cover the end surface 37R of the yoke 37. The inner coil stoppers 44 are connected to the annular portion 49. The inner coil stoppers 44 are disposed radially inside the coils 35. The inner coil stoppers 44 support the coils 35 from radially inside. The outer coil stoppers 45 each protrude rearward from the annular portion 49. The outer coil stoppers 45 are disposed radially outside the coils 35. The outer coil stoppers 45 support the coils 35 from radially outside.

The coils 35 are formed by winding a single wire. The coils 35 adjacent to each other in the circumferential direction are connected by a connecting wire that is a part of the wire. The connecting wires are supported by the insulator 34.

Each of the six coils 35 is assigned to any one of a U (U-V) phase, a V (V-W) phase, and a W (W-U) phase. Among the six coils 35, two coils 35 are U-phase coils allocated to the U phase, two coils 35 are V-phase coils allocated to the V phase, and two coils 35 are W-phase coils allocated to the W phase.

Each of the short-circuiting members 36 is a conductive member. The drive current from the battery pack 19 is supplied to the short-circuiting members 36 via the controller 9. The drive current supplied from the battery pack 19 to the short-circuiting members 36 is controlled by the controller 9. The drive current flows through the short-circuiting members 36. The short-circuiting members 36 send the drive current from the battery pack 19 to the coils 35.

In the present embodiment, three of the short-circuiting members 36 are provided. Each of the three short-circuiting members 36 is assigned to any one of the U phase, the V phase, and the W phase. Among the three short-circuiting members 36, one short-circuiting member 36 is a U-phase short-circuiting member assigned to the U phase, one short-circuiting member 36 is a V-phase short-circuiting member assigned to the V phase, and one short-circuiting member 36 is a W-phase short-circuiting member assigned to the W phase.

The short-circuiting members 36 each includes a power supply terminal 39 and a fusing terminal (not illustrated). The power supply terminals 39 are disposed on (in) a lower portion of the short-circuiting members 36, as shown in FIG. 9. The three power supply terminals 39 are supported by the terminal support 47. The three power supply terminals 39 are disposed in the left-right direction. The power supply terminals 39 are connected to the battery pack 19 via the controller 9.

The drive current from the battery pack 19 is supplied to the power supply terminals 39 via power supply lines (not illustrated). One power supply line is fixed to one power supply terminal 39. Among three of the power supply lines, one power supply line is a U-phase power supply line fixed to the power supply terminal 39 of the U-phase short-circuiting member, one power supply line is a V-phase power supply line fixed to the power supply terminal 39 of the V-phase short-circuiting member, and one power supply line is a W-phase power supply line fixed to the power supply terminal 39 of the W-phase short-circuiting member.

The power supply lines and the power supply terminals 39 are fixed by screws 52. The screws 52 are respectively inserted into screw openings 40 provided in the power supply terminals 39, and then inserted into the screw holes 46 provided in the terminal support 47.

The short-circuiting members 36 are connected to the coils 35 via fusing terminals (not illustrated). The short-circuiting members 36 connect the power supply terminals 39 and the fusing terminals. The drive current from the battery pack 19 is supplied to the power supply terminals 39 of the short-circuiting members 36 via the controller 9 and the power supply lines. The drive current supplied from the battery pack 19 to the power supply terminals 39 flows through the short-circuiting members 36 including the power supply terminals 39, and then is supplied to the coils 35.

The drive current supplied from the battery pack 19 to the motor 20 includes a U-phase drive current, a V-phase drive current, and a W-phase drive current. The U-phase drive current is supplied to the U-phase power supply terminal via the U-phase power supply line, and then supplied to the U-phase coil via the U-phase short-circuiting member. The V-phase drive current is supplied to the V-phase power supply terminal via the V-phase power supply line, and then supplied to the V-phase coil via the V-phase short-circuiting member. The W-phase drive current is supplied to the W-phase power supply terminal via the W-phase power supply line, and then supplied to the W-phase coil via the W-phase short-circuiting member.

Two of the short-circuiting members 36 have screw openings 50 that align with two screw bosses 43. Two of the short-circuiting members 36 are fixed to the front insulator 34F by two screws 51. The screws 51 are inserted into the screw openings 50 provided in the short-circuiting members 36 and then inserted into screw hole of the screw bosses 43.

The sensor substrate 22A detects the rotation of the rotor 23. At least a part of the sensor substrate 22A is disposed at a position facing the end surface 27F of the rotor 23 in the axial direction.

The sensor substrate 22A includes rotation sensors 60, a plate 70, and signal lines 80. In FIG. 5, the plate 70 is illustrated by a virtual line.

The rotation sensors 60 detect the rotation of the rotor 23. The rotation sensors 60 detect the position of the rotor 23 in the rotation direction by detecting the position of the permanent magnets 29 supported by the rotor core 27. The rotation sensors 60 are magnetic sensors including a Hall element. Three of the rotation sensors 60 are provided. The three rotation sensors 60 are arranged on a virtual circle centered on the rotation axis AX. The three rotation sensors 60 are arranged at intervals of 60 degrees around the rotation axis AX.

The rotation sensors 60 are disposed at positions facing the end surface 27F of the rotor core 27 in the axial direction. The rotation sensors 60 are disposed radially inside the coil 35. The rotation sensors 60 are disposed radially inside the inner coil stoppers 41.

Assuming that a position of an upper end in the circumferential direction is a position of 0 degrees, a position of a left end in the circumferential direction is a position of 90 degrees, a position of a lower end in the circumferential direction is a position of 180 degrees, and a position of a right end in the circumferential direction is a position of 270 degrees; the power supply terminals 39 is disposed at a position of 180 degrees. A first rotation sensor 60 is arranged at a position of 120 degrees, a second rotation sensor 60 is arranged at a position of 240 degrees, and a third rotation sensor 60 is arranged at a position of 180 degrees.

The plate 70 supports the rotation sensors 60. The plate 70 is a parallel flat plate. A front surface of the plate 70 facing forward is a substantially flat surface. A rear surface of the plate 70 facing rearward is a substantially flat surface. The front surface of the plate 70 and the rear surface of the plate 70 are substantially parallel. The plate 70 includes a printed wiring board (PWB). The plate 70 is manufactured by cutting a single rectangular printed wiring board (PWB).

The plate 70 includes an arc portion 71 and arm portions 72.

The arc portion 71 extends partially around the rotation axis AX. The arc portion 71 has an first surface 71A facing the end surface 27F of the rotor 23 in the axial direction, and a second surface 71B facing in a direction opposite to a direction in which the first surface 71A faces. The rotation sensors 60 are disposed on the first surface 71A. In the embodiment, the first surface 71A is a part of the rear surface of the plate 70 facing rearward. The second surface 71B is a part of the front surface of the plate 70 facing forward.

The arc portion 71 is disposed at a position facing the end surface 27F of the rotor core 27 in the axial direction. The arc portion 71 is disposed radially inside the coils 35. The arc portion 71 is disposed radially inside the inner coil stoppers 41.

Assuming that the position of the upper end in the circumferential direction is the position of 0 degrees, the position of the left end in the circumferential direction is the position of 90 degrees, the position of the lower end in the circumferential direction is the position of 180 degrees, and the position of the right end in the circumferential direction is the position of 270 degrees; the arc portion 71 is disposed in a range of approximately 110 degrees to 250 degrees. The first rotation sensor 60 is disposed at one end of the arc portion 71 in the circumferential direction, the second rotation sensor 60 is disposed at the other end of the arc portion 71 in the circumferential direction, and the third rotation sensor 60 is disposed at a center of the arc portion 71 in the circumferential direction.

The arm portions 72 each protrude outward in the radial direction from the arc portion 71. At least two of the arm portions 72 are provided. In the present embodiment, the arm portions 72 include a first arm portion 721, a second arm portion 722, and a third arm portion 723.

The first arm portion 721 protrudes outward in the radial direction from one end of the arc portion 71 in the circumferential direction. The second arm portion 722 protrudes outward in the radial direction from the other end of the arc portion 71 in the circumferential direction. The third arm portion 723 protrudes outward in the radial direction from the center of the arc portion 71 in the circumferential direction. In the radial direction, a dimension of the first arm portion 721 is equivalent to a dimension of the second arm portion 722. In the radial direction, a dimension of the third arm portion 723 is larger than the dimension of the first arm portion 721 and the dimension of the second arm portion 722. In the radial direction, a distance between the rotation axis AX and a radially outer end of the third arm portion 723 is longer than a distance between the rotation axis AX and a radially outer end of the first arm portion 721 (second arm portion 722).

Radially outer ends of the arm portions 72 are disposed radially outside the coils 35. Each of the radially outer end of the first arm portion 721, the radially outer end of the second arm portion 722, and the radially outer end of the third arm portion 723 is disposed radially outside the coils 35.

The plate 70 is fixed to the front insulator 34F. The arm portions 72 and the front insulator 34F are fixed. In the embodiment, the radially outer end of the first arm portion 721 and the radially outer end of the second arm portion 722 are fixed to the front insulator 34F. Screw openings 53 are provided at the radially outer ends of the first arm portion 721 and the second arm portion 722, respectively. The first arm portion 721 and the second arm portion 722 are fixed to the front insulator 34F by the screws 51. The screws 51 are inserted into the screw openings 53 and the screw openings 50 provided in the short-circuiting members 36, and then inserted into the screw holes of the screw bosses 43.

The third arm portion 723 is disposed on the front side of the power supply terminals 39. In a plane orthogonal to the rotation axis AX, the third arm portion 723 is disposed so as to overlap the power supply terminals 39.

The signal lines 80 connect the rotation sensors 60 and the controller 9. Detection signals of the rotation sensors 60 are transmitted to the controller 9 via the signal lines 80. The controller 9 controls the drive current supplied from the battery pack 19 to the coils 35 according to the detection signals of the rotation sensors 60. Five of the signal lines 80 are provided. The signal lines 80 are supported on the third arm portion 723. The signal lines 80 are disposed on a front surface of the third arm portion 723.

In the axial direction, the first surface 71A is disposed at a position closer to the center of the coil 35 than a front end 35F of the coil 35 is to the center of the coil 35. In the axial direction, the second surface 71B is also disposed at a position closer to the center of the coil 35 than the front end 35F of the coil 35 is to the center of the coil 35. In other words, both the first surface 71A and the second surface 71B are disposed rearward of the front end 35F of the coil 35. In the present embodiment, the plate 70 is a parallel flat plate.

In the axial direction, both the rear surface and the front surface of the plate 70 are disposed rearward of the front end 35F of the coil 35. The arc portion 71 that supports the rotation sensors 60 is disposed radially inside the coil 35 so that the rotation sensors 60 do not come into contact with the rotor core 27 and the permanent magnets 29.

Each of the arm portions 72 is disposed between a pair of the coils 35 adjacent to each other in the circumferential direction. Assuming that the position of the upper end in the circumferential direction is 0 degrees, the position of the left end in the circumferential direction is 90 degrees, the position of the lower end in the circumferential direction is 180 degrees, and the position of the right end in the circumferential direction is 270 degrees; the first coil 35 is disposed at a position of 30 degrees, the second coil 35 is disposed at a position of 90 degrees, the third coil 35 is disposed at a position of 150 degrees, the fourth coil 35 is disposed at a position of 210 degrees, the fifth coil 35 is disposed at a position of 270 degrees, and the sixth coil 35 is disposed at a position of 330 degrees. The first arm portion 721 is arranged at a position of 120 degrees, the third arm portion 723 is arranged at a position of 180 degrees, and the second arm portion 722 is arranged at a position of 240 degrees. At least a part of the first arm portion 721 is disposed between the second coil 35 and the third coil 35. At least a part of the third arm portion 723 is disposed between the third coil 35 and the fourth coil 35. At least a part of the second arm portion 722 is disposed between the fourth coil 35 and the fifth coil 35.

### Effects

As described above, in the present embodiment, the electric work machine 1 may include the motor 20 including the rotor 23 that rotates about the rotation axis AX and the stator 24 disposed around the rotor 23, and the sensor substrate 22A including the rotation sensor 60 that detects the rotation of the rotor 23 and the plate 70 that supports the rotation sensor 60. The stator 24 may include the stator core 33 disposed around the rotor 23, the insulator 34 fixed to the stator core 33, and the plurality of coils 35 fixed to the insulator 34 and disposed at intervals in the circumferential direction. The plate 70 may include the arc portion 71 extending partially around the rotation axis AX and having an first surface 71A facing the end surface 27F of the rotor 23 in the axial direction, and at least two arms 72 protruding outward in the radial direction from the arc portion 71 and fixed to the insulator 34. The rotation sensor 60 may be disposed on the first surface 71A.

In the above configuration, since a part of the plate 70 of the sensor substrate 22A is the arc portion 71, the sensor substrate 22A is reduced in size and weight. Since a part of the plate 70 fixed to the insulator 34 is the arm portions 72, the sensor substrate 22A is reduced in size and weight. Since the sensor substrate 22A is reduced in size and weight, the motor assembly 6 including the motor 20 and the sensor substrate 22A is reduced in size and weight. As a result, the electric work machine 1 is reduced in size and weight. In addition, many plates 70 are manufactured from one printed wiring board (PWB) having a rectangular shape.

In the present embodiment, the arc portion 71 may be disposed radially inside the coil 35.

In the above configuration, the motor assembly 6 is downsized in the radial direction.

In the present embodiment, the radially outer ends of the arm portions 72 may be disposed radially outside the coil 35. The ends of the arm portions 72 may be fixed to the insulator 34.

In the above configuration, the sensor substrate 22A is fixed to the insulator 34 by fixing the ends of the arm portions 72 to the insulator 34.

In the present embodiment, the first surface 71A may be disposed at a position closer to the center of the coil 35 than the front end 35F of the coil 35 in the axial direction.

In the above configuration, since at least a part of the arc portion 71 is positioned radially inside the coil 35, the motor assembly 6 is downsized in the axial direction.

In the present embodiment, the arc portion 71 may have the second surface 71B facing in the direction opposite to the direction in which the first surface 71A faces. In the axial direction, the second surface 71B may be disposed at a position closer to the center of the coil 35 than the front end 35F of the coil 35.

In the above configuration, since the entire arc portion 71 is positioned radially inside the coil 35, the motor assembly 6 is downsized in the axial direction.

In the present embodiment, the plate 70 may be a parallel flat plate.

In the above configuration, the plate 70 is manufactured from a printed wiring board (PWB).

In the present embodiment, each of the arm portions 72 may be disposed between a pair of coils 35 adjacent to each other.

In the above configuration, even when the plate 70 is the parallel flat plate, at least a part of the arc portion 71 is positioned radially inside the coil 35.

In the present embodiment, the arm portions 72 may include the first arm portion 721 and the second arm portion 722. The first arm portion 721 may protrude outward in the radial direction from one end of the arc portion 71 in the circumferential direction, and the second arm portion 722 may protrude outward in the radial direction from the other end of the arc portion 71 in the circumferential direction.

In the above configuration, bending or vibration at the ends of the arc portion 71 in the circumferential direction is suppressed.

In the present embodiment, the arm portions 72 may include the third arm portion 723. The third arm portion 723 may protrude outward in the radial direction from the center of the arc portion 71 in the circumferential direction.

In the above configuration, the sensor substrate 22A is sufficiently fixed to the insulator 34 by fixing each of the first arm portion 721, the second arm portion 722, and the third arm portion 723 to the insulator 34.

In the present embodiment, the electric work machine 1 may include the controller 9 that controls the drive current supplied to the coils 35 based on the detection signal of the rotation sensor 60, and the signal line 80 that connects the rotation sensor 60 and the controller 9. The signal line 80 may be supported by the third arm portion 723.

In the above configuration, the signal line 80 is supported by the third arm portion 723 of the plate 70.

In the present embodiment, the electric work machine 1 may include the power supply terminal 39 through which the drive current flows. In the plane orthogonal to the rotation axis AX, the third arm portion 723 may be disposed so as to overlap the power supply terminal 39.

With the above configuration, an increase in size of the motor assembly 6 in the radial direction is suppressed.

In the present embodiment, each of the first arm portion 721 and the second arm portion 722 may be fixed to the insulator 34 by the screws 51.

In the above configuration, the sensor substrate 22A can be easily replaced with a new sensor substrate 22A by detaching the screws 51.

In the present embodiment, at least one of the first arm portion 721, the second arm portion 722, and the third arm portion 723 may be fixed to the insulator 34 by the screws 51. For example, the third arm portion 723 may be fixed to the insulator 34 by the screw 51, and the first arm portion 721 and the second arm portion 722 may not be fixed to the insulator 34. Alternatively, all of the first arm portion 721, the second arm portion 722, and the third arm portion 723 may be fixed to the insulator 34 by the screws 51.

### Second Embodiment

A second embodiment will be described. In the following description, the same or equivalent components as those of the above-described embodiment are denoted by the same reference signs, and the description of the components is simplified or omitted.

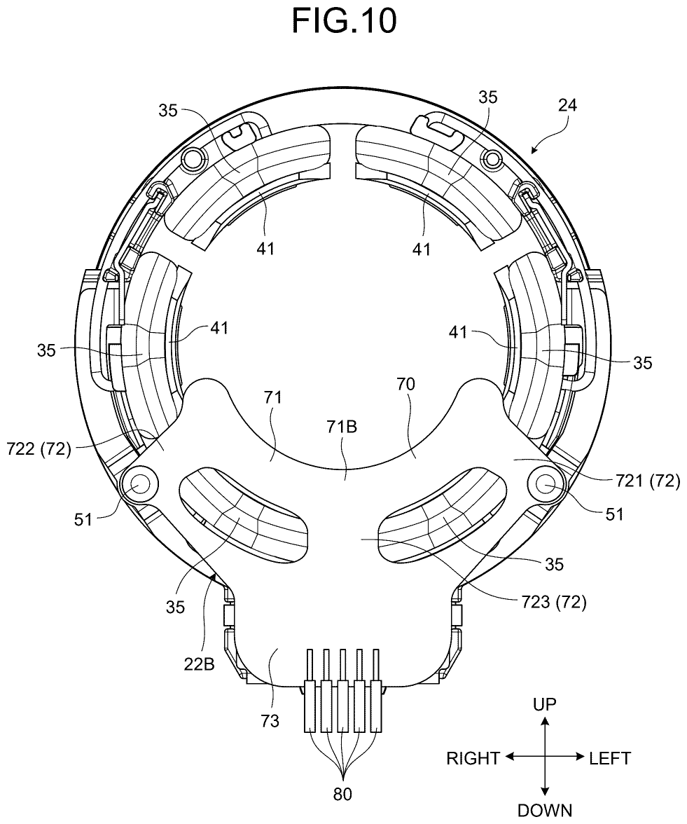

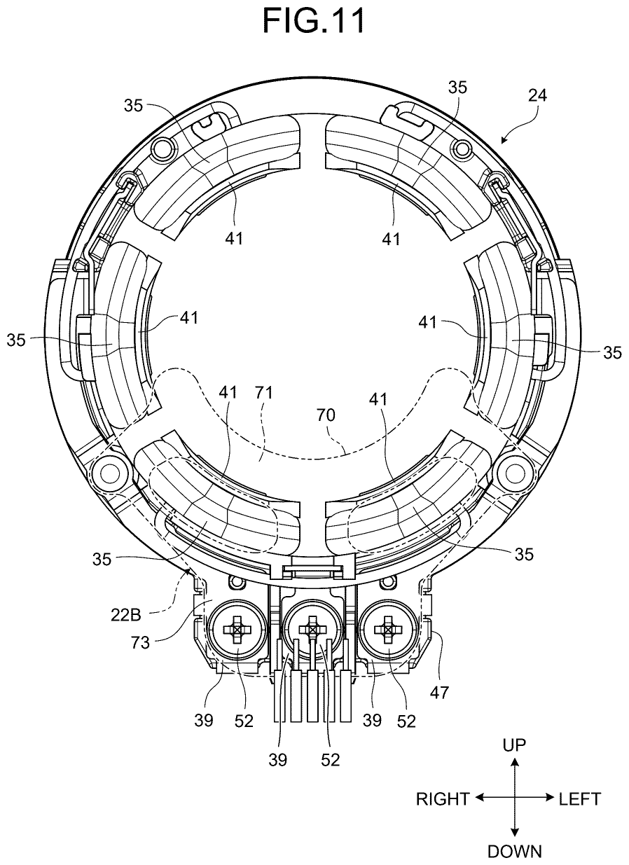

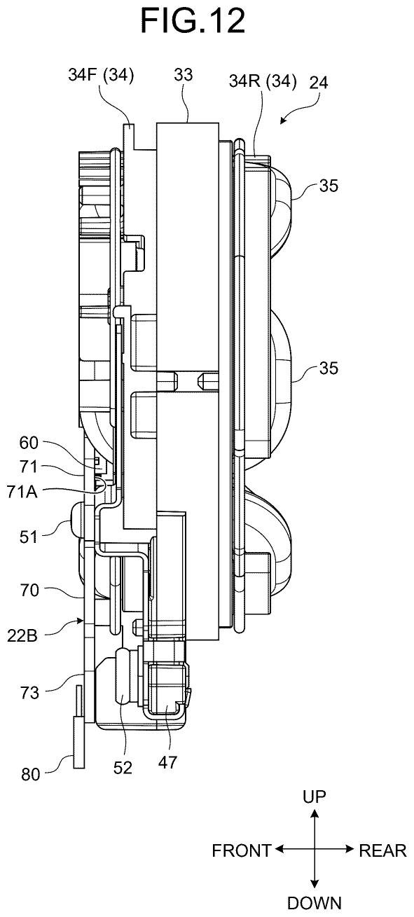

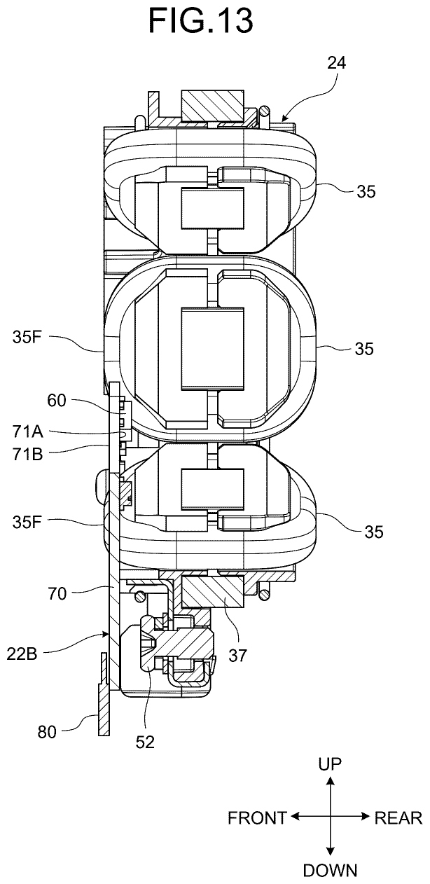

FIG. 10 is a front view of the stator 24 and a sensor substrate 22B according to the present embodiment. FIG. 11 is a front view of the stator 24 according to the present embodiment. FIG. 12 is a left side view of the stator 24 and the sensor substrate 22B according to the present embodiment. FIG. 13 is a cross-sectional view illustrating the stator 24 and the sensor substrate 22B according to the present embodiment. In FIG. 11, the plate 70 is illustrated by a virtual line.

In the present embodiment, the plate 70 includes the arc portion 71, the first arm portion 721, the second arm portion 722, the third arm portion 723, and a cover portion 73 that connects radially outer ends of the first arm portion 721, the second arm portion 722, and the third arm portion 723. The cover portion 73 is disposed radially outside the coils 35. In the present embodiment, the plate 70 has two openings. One opening is defined by the arc portion 71, the first arm portion 721, the third arm portion 723, and the cover portion 73. The other opening is defined by the arc portion 71, the second arm portion 722, the third arm portion 723, and the cover portion 73. In a plane orthogonal to the rotation axis AX, one opening overlaps at least a part of one coil 35, and the other opening overlaps at least a part of another one coil 35.

The cover portion 73 is disposed on the front side of the power supply terminals 39. In the plane orthogonal to the rotation axis AX, the cover portion 73 is disposed so as to overlap the power supply terminals 39. The signal lines 80 are supported on the front surface of the cover portion 73.

In the axial direction, the first surface 71A is disposed at a position closer to the center of the coil 35 than a front end 35F of the coil 35. In the axial direction, the second surface 71B is also disposed at a position closer to the center of the coil 35 than the front end 35F of the coil 35. In other words, each of the first surface 71A and the second surface 71B is disposed rearward of the front end 35F of the coil 35.

As described above, in the present embodiment, the plate 70 may include the cover portion 73 that connects the radially outer ends of the first arm portion 721, the second arm portion 722, and the third arm portion 723.

In the above configuration, the strength of the plate 70 is improved.

In the present embodiment, the electric work machine 1 may include: the controller 9 that controls the drive current supplied to the coils 35 based on the detection signals of the rotation sensors 60; and the signal lines 80 that connects the rotation sensors 60 and the controller 9. The signal lines 80 may be supported on the cover portion 73.

In the above configuration, the signal lines 80 are supported on the cover portion 73 of the plate 70.

In the present embodiment, the electric work machine 1 may include the power supply terminals 39 through which the drive current flows. In the plane orthogonal to the rotation axis AX, the cover portion 73 may be disposed so as to overlap the power supply terminals 39.

With the above configuration, an increase in size of the motor assembly 6 in the radial direction is suppressed.

### Third Embodiment

A third embodiment will be described. In the following description, the same or equivalent components as those of the above-described embodiments are denoted by the same reference signs, and the description of the components is simplified or omitted.

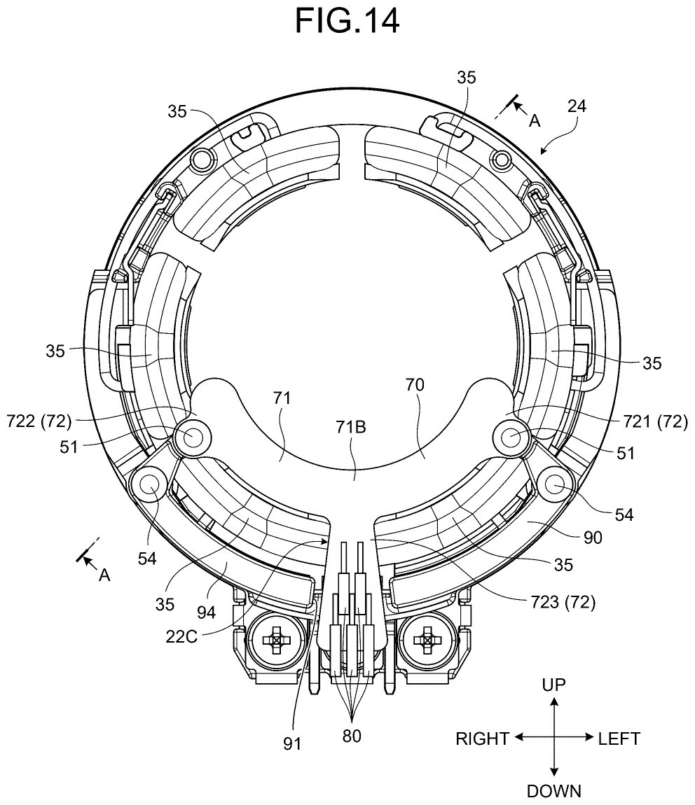

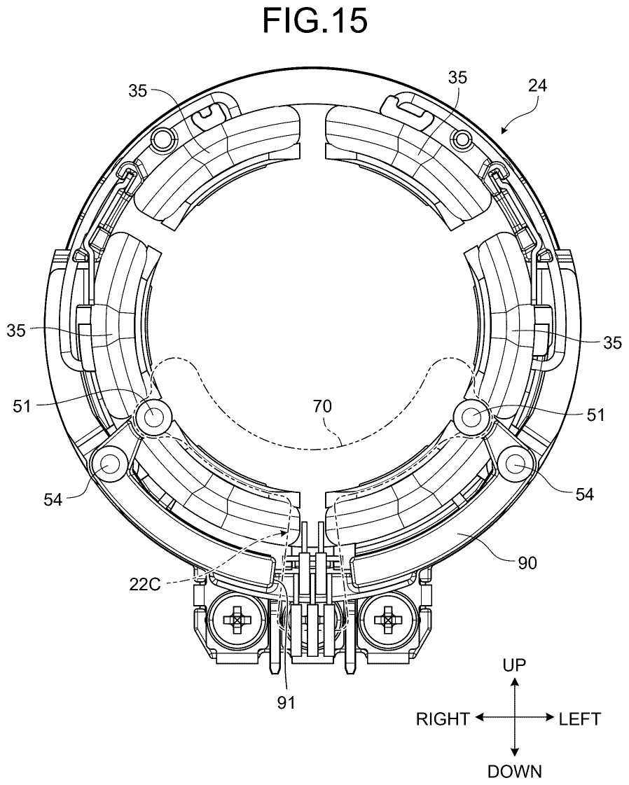

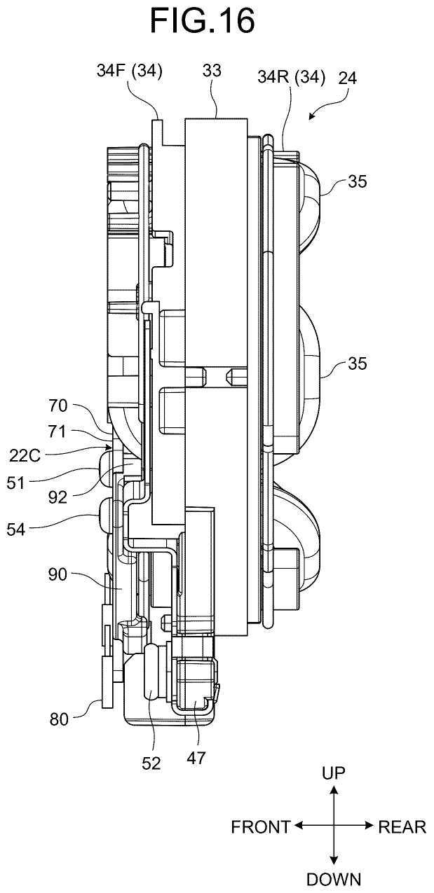

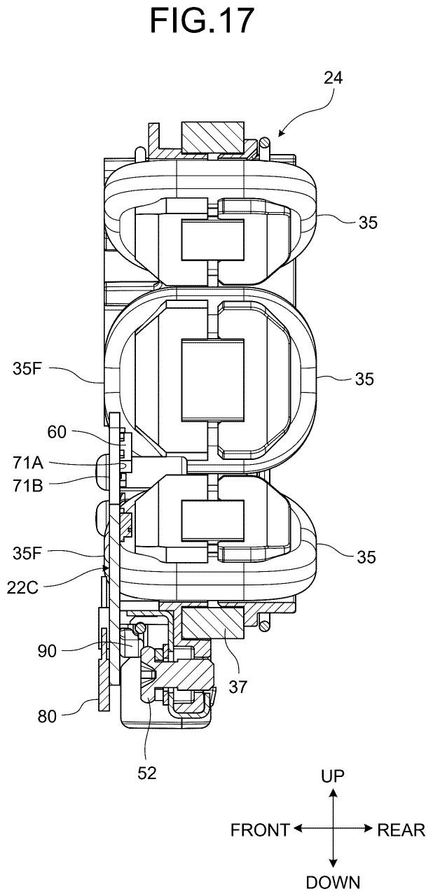

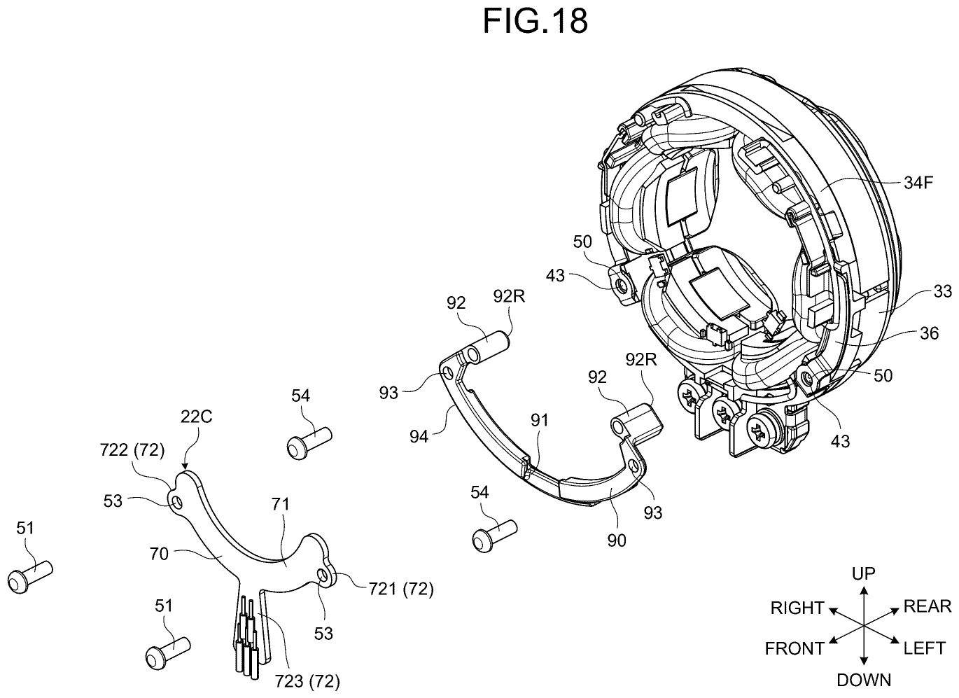

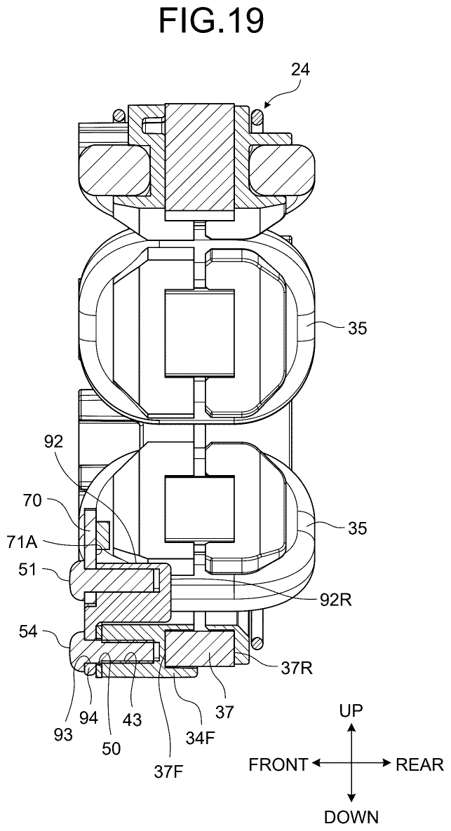

FIG. 14 is a front view of the stator 24 and a sensor substrate 22C according to the present embodiment. FIG. 15 is a front view of the stator 24 according to the present embodiment. FIG. 16 is a left side view of the stator 24 and the sensor substrate 22C according to the present embodiment. FIG. 17 is a cross-sectional view illustrating the stator 24 and the sensor substrate 22C according to the present embodiment. FIG. 18 is an exploded front perspective view illustrating the stator 24 and the sensor substrate 22C according to the present embodiment. FIG. 19 is a cross-sectional view illustrating the stator 24 and the sensor substrate 22C according to the present embodiment. In FIG. 15, the plate 70 is illustrated by a virtual line. FIG. 19 corresponds to a cross-sectional arrow view taken along line A-A in FIG. 14.

The plate 70 includes the arc portion 71, the first arm portion 721, the second arm portion 722, and the third arm portion 723. In the present embodiment, the motor assembly 6 has a support member 90 fixed to the front insulator 34F.

At least two arm portions 72 are fixed to the front insulator 34F via the support member 90. In the present embodiment, the first arm portion 721 and the second arm portion 722 are fixed to the support member 90 by the screws 51 (second screws).

The support member 90 includes a support arc portion 94 and screw bosses 92.

The support arc portion 94 extends partially around the rotation axis AX. The support arc portion 94 is disposed radially outside the coils 35. In a plane orthogonal to the rotation axis AX, the support arc portion 94 is disposed so as to overlap the annular portion 48 of the front insulator 34F.

Assuming that the position of the upper end in the circumferential direction is a position of 0 degrees, the position of the left end in the circumferential direction is a position of 90 degrees, the position of the lower end in the circumferential direction is a position of 180 degrees, and the position of the right end in the circumferential direction is a position of 270 degrees; the support arc portion 94 is arranged in a range of approximately 110 degrees to 250 degrees.

The support arc portion 94 is fixed to the front insulator 34F by screws 54 (first screw). Screw openings 93 are respectively provided at one end and the other end of the support arc portion 94 in the circumferential direction. The screws 54 are inserted into the screw openings 50 provided in the short-circuiting members 36, and then inserted into the screw holes of the screw bosses 43 provided in the front insulator 34F.

The screw bosses 92 are respectively connected to one end and the other end of the support arc portion 94 in the circumferential direction. The screw bosses 92 are disposed radially inside the support arc portion 94. The two arms 72 are fixed to the screw bosses 92 by the screws 51 (second screws). The first arm portion 721 is fixed to one screw boss 92 by the screw 51, and the second arm portion 722 is fixed to the other screw boss 92 by the screw 51. One screw 51 is inserted into the screw opening 53 provided in the first arm portion 721 and then inserted into a screw hole of one screw boss 92. The other screw 51 is inserted into the screw opening 53 provided in the second arm portion 722 and then inserted into a screw hole of the other screw boss 92.

A recess 91 is provided at a center of the support arc portion 94 in the circumferential direction. The recess 91 is recessed rearward from the front surface of the support arc portion 94. At least a part of the third arm portion 723 is disposed in the recess 91.

The arc portion 71 is disposed radially inside the support arc portion 94. The arc portion 71 is disposed radially outside the coils 35.

As illustrated in FIG. 19, each of the screw bosses 92 has an end surface 92R facing in the same direction as the first surface 71A in the axial direction. The end surface 92R faces rearward. The end surface 92R is a rear end surface of the screw boss 92. The end surface 37F of the yoke 37 of the stator core 33 faces in a direction opposite to the direction in which the first surface 71A faces. In the axial direction, the end surface 92R of each of the screw bosses 92 is disposed at a position closer to the center of the coil 35 than the end surface 37F of the yoke 37 of the stator core 33. In other words, the end surface 92R of each of the screw bosses 92 is disposed rearward of the end surface 37F of the yoke 37 of the stator core 33.

In the axial direction, the first surface 71A is disposed at a position closer to the center of the coil 35 than a front end 35F of the coil 35. In the axial direction, the second surface 71B is also disposed at a position closer to the center of the coil 35 than the front end 35F of the coil 35. In other words, both the first surface 71A and the second surface 71B are disposed rearward of the front end 35F of the coil 35.

As described above, in the present embodiment, the electric work machine 1 may include the support member 90 fixed to the insulator 34. At least the two arms 72 may be fixed to the insulator 34 via the support member 90.

In the above configuration, the plate 70 is fixed to the insulator 34 via the support member 90. Even when the plate 70 is the parallel flat plate, the plate 70 and the insulator 34 are appropriately fixed to each other via the support member 90 by adjusting the shape of the support member 90.

In the present embodiment, the support member 90 may include: the support arc portion 94 fixed to the insulator 34 by the screws 54 that are the first screws; and the screw bosses 92 which are disposed radially inside the support arc portion 94 and to which the arm portions 72 are fixed by the screws 51 that are the second screws. In the axial direction, the end surface 92R of each of the screw bosses 92 facing in the same direction as the first surface 71A may be disposed at a position closer to the center of the coil 35 than the end surface 37F, which faces in a direction opposite to the direction in which the first surface 71A faces, of the stator core 33.

In the above configuration, the plate 70 is stably fixed to the insulator 34 via the support member 90. Since the screw bosses 92 are disposed radially inside the support arc portion 94, a length of each of the screw bosses 92 is not restricted. In other words, since each of the screw bosses 92 is disposed radially inside the yoke 37 of the stator core 33 and is disposed between the pair of teeth 38 adjacent to each other, the length of each of the screw bosses 92 is not restricted. In a case where the plate 70 is disposed rearward of the front end 35F of the coil 35 and the plate 70 is fixed to the insulator 34 by the screws 51; when the screws 51 are assumed to be long, leading ends of the screws 51 may hit the end surface 37F of the stator core 33. Thus, the screws 51 may need to be shortened. When the screws 51 are assumed to be short, the fixing between the plate 70 and the insulator 34 may become unstable. In the present embodiment, since the length of each of the screw bosses 92 is not restricted, a long screw 51 can be used even when the plate 70 is disposed rearward of the front end 35F of the coil 35. Therefore, the plate 70 is stably fixed to the insulator 34 via the support member 90.

### Fourth Embodiment

A fourth embodiment will be described. In the following description, the same or equivalent components as those of the above-described embodiments are denoted by the same reference signs, and the description of the components is simplified or omitted.

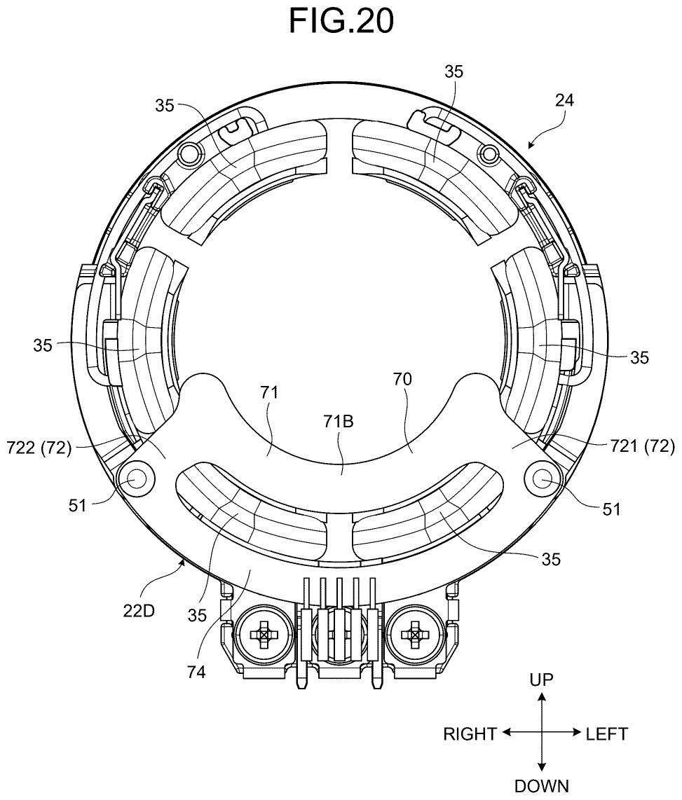

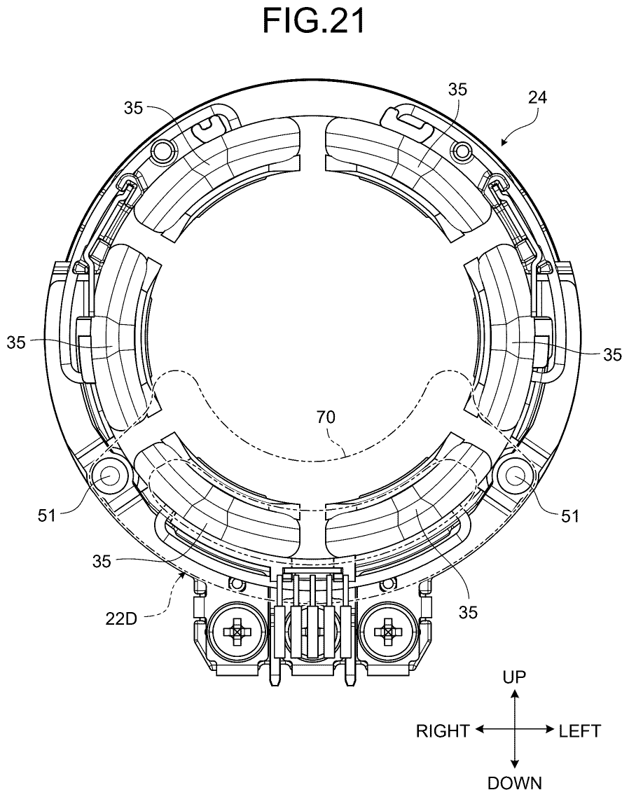

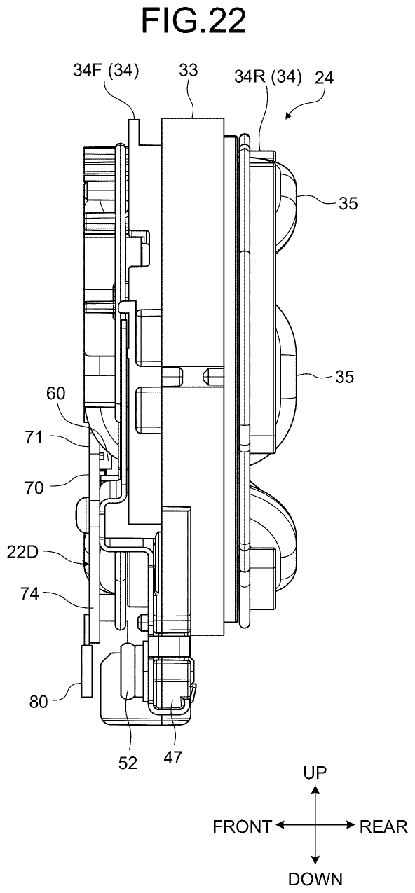

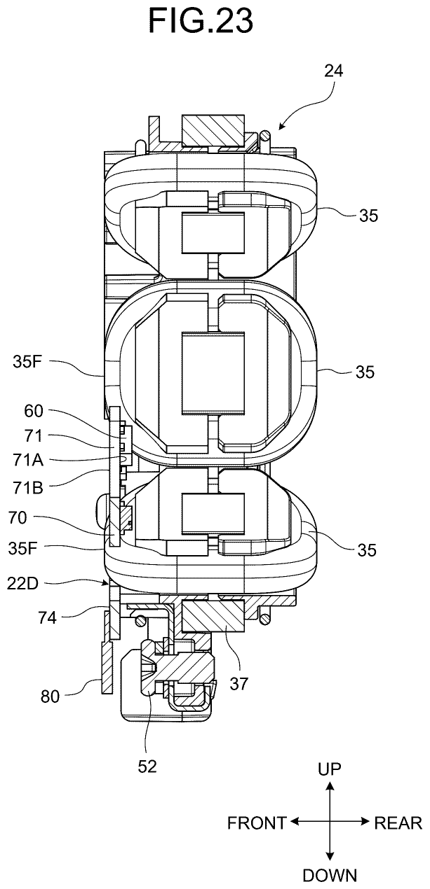

FIG. 20 is a front view of the stator 24 and a sensor substrate 22D according to the present embodiment. FIG. 21 is a front view of the stator 24 according to the present embodiment. FIG. 22 is a left side view of the stator 24 and the sensor substrate 22D according to the present embodiment. FIG. 23 is a cross-sectional view of the stator 24 and the sensor substrate 22D according to the present embodiment. In FIG. 21, the plate 70 is illustrated by a virtual line.

In the present embodiment, the plate 70 includes the arc portion 71, the first arm portion 721, the second arm portion 722, and a bridge portion 74 connecting the radially outer end of the first arm portion 721 and the radially outer end of the second arm portion 722. The bridge portion 74 is disposed radially outside the coils 35. In the present embodiment, the plate 70 does not include the third arm portion 723.

The bridge portion 74 has an arc shape extending partially around the rotation axis AX. The bridge portion 74 is disposed radially outside the coils 35. In a plane orthogonal to the rotation axis AX, the bridge portion 74 is disposed so as to overlap the annular portion 48 of the front insulator 34F.

Assuming that the position of the upper end in the circumferential direction is a position of 0 degrees, the position of the left end in the circumferential direction is a position of 90 degrees, the position of the lower end in the circumferential direction is a position of 180 degrees, and the position of the right end in the circumferential direction is a position of 270 degrees; the bridge portion 74 is disposed in a range of approximately 110 degrees to 250 degrees.

In the present embodiment, the plate 70 has one opening. The opening is defined by the arc portion 71, the first arm portion 721, the second arm portion 722, and the bridge portion 74. In the plane orthogonal to the rotation axis AX, the opening and two coils 35 overlap.

The bridge portion 74 is disposed radially inside the power supply terminals 39. The signal lines 80 are supported on a front surface of the bridge portion 74.

In the axial direction, the first surface 71A is disposed at a position closer to the center of the coil 35 than a front end 35F of the coil 35. In the axial direction, the second surface 71B is also disposed at a position closer to the center of the coil 35 than the front end 35F of the coil 35. In other words, each of the first surface 71A and the second surface 71B is disposed rearward of the front end 35F of the coil 35.

As described above, in the present embodiment, the plate 70 may have the bridge portion 74 connecting the radially outer ends of the first arm portion 721 and the second arm portion 722.

In the above configuration, the strength of the plate 70 is improved.

In the present embodiment, the bridge portion 74 may have an arc shape extending partially around the rotation axis AX.

With the above configuration, an increase in size of the motor assembly 6 in the radial direction is suppressed.

In the present embodiment, the electric work machine 1 may include the controller 9 that controls the drive current supplied to the coils 35 based on the detection signals of the rotation sensors 60, and the signal lines 80 that connect the rotation sensors 60 and the controller 9. The signal lines 80 may be supported on the bridge portion 74.

In the above configuration, the signal line 80 is supported by the bridge portion 74 of the plate 70.

### Fifth Embodiment

A fifth embodiment will be described. In the following description, the same or equivalent components as those of the above-described embodiments are denoted by the same reference signs, and the description of the components is simplified or omitted.

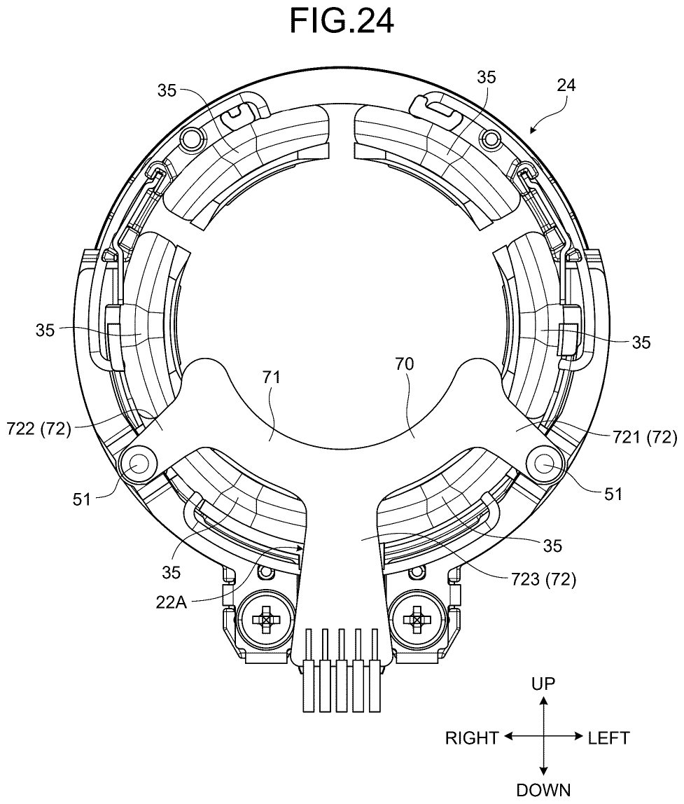

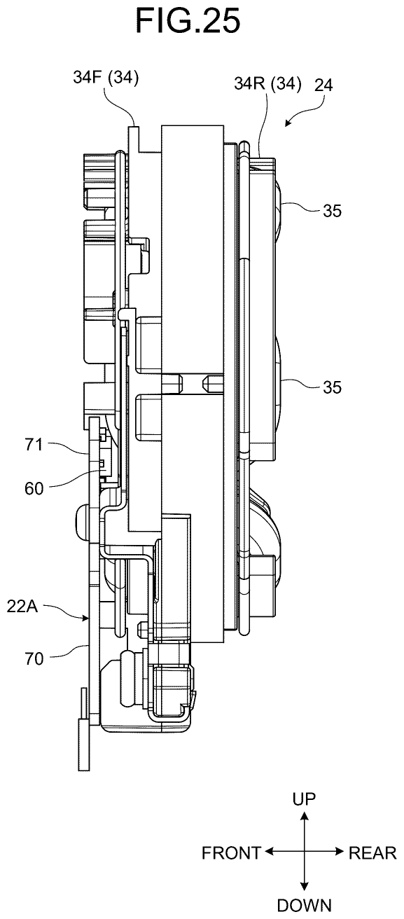

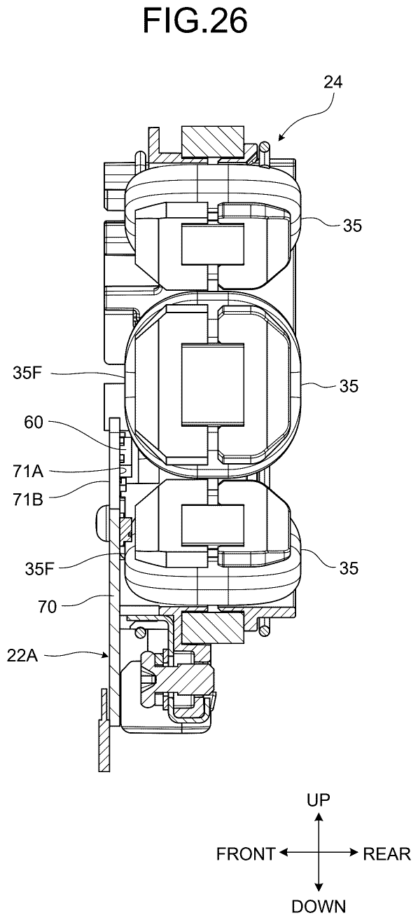

FIG. 24 is a front view of the stator 24 and the sensor substrate 22A according to the present embodiment. FIG. 25 is a left side view of the stator 24 and the sensor substrate 22A according to the present embodiment. FIG. 26 is a cross-sectional view of the stator 24 and the sensor substrate 22A according to the present embodiment.

The present embodiment is a modification of the first embodiment described above. In the first embodiment described above, each of the first surface 71A and the second surface 71B of the sensor substrate 22A is disposed at a position closer to the center of the coil 35 than the front end 35F of the coil 35. In other words, both the first surface 71A and the second surface 71B are disposed rearward of the front end 35F of the coil 35.

In the present embodiment, each of the first surface 71A and the second surface 71B of the sensor substrate 22A is disposed at a position farther from the center of the coil 35 than the front end 35F of the coil 35 is. In other words, both the first surface 71A and the second surface 71B are disposed forward of the front end 35F of the coil 35.

As described above, both the first surface 71A and the second surface 71B of the sensor substrate 22A may be disposed forward of the front end 35F of the coil 35.

### Sixth Embodiment

A sixth embodiment will be described. In the following description, the same or equivalent components as those of the above-described embodiments are denoted by the same reference signs, and the description of the components is simplified or omitted.

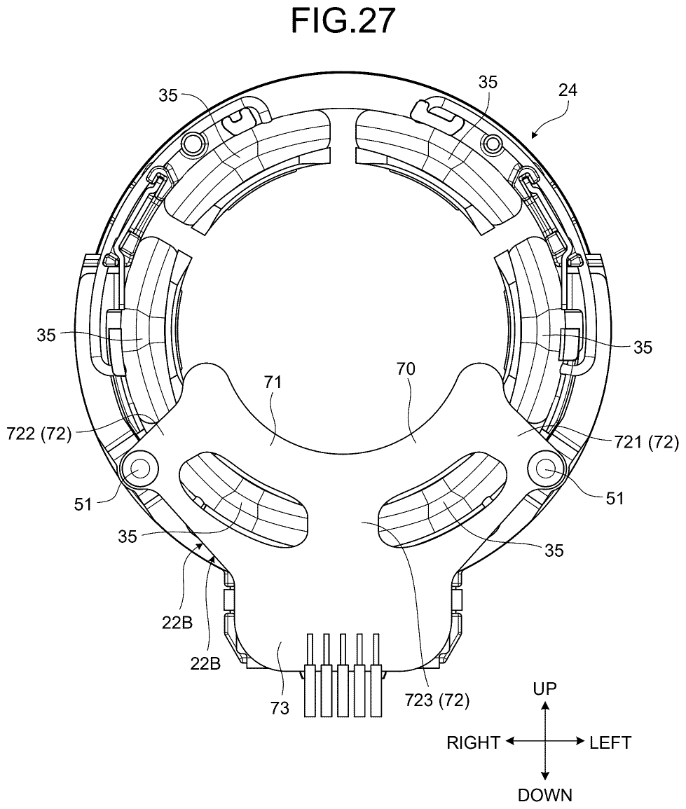

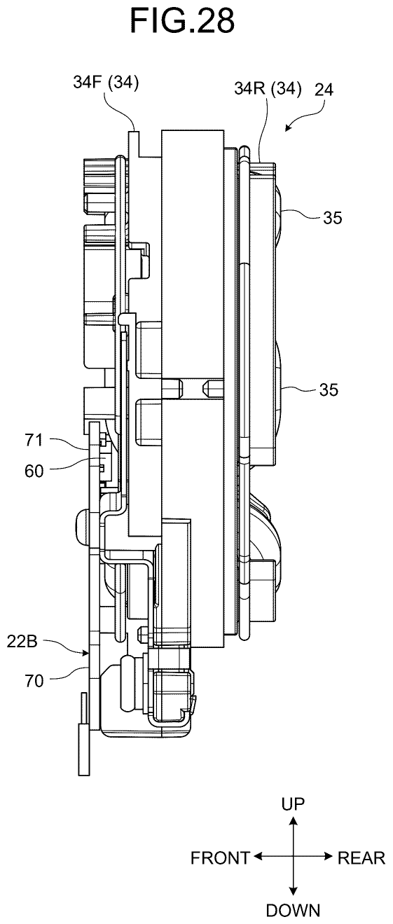

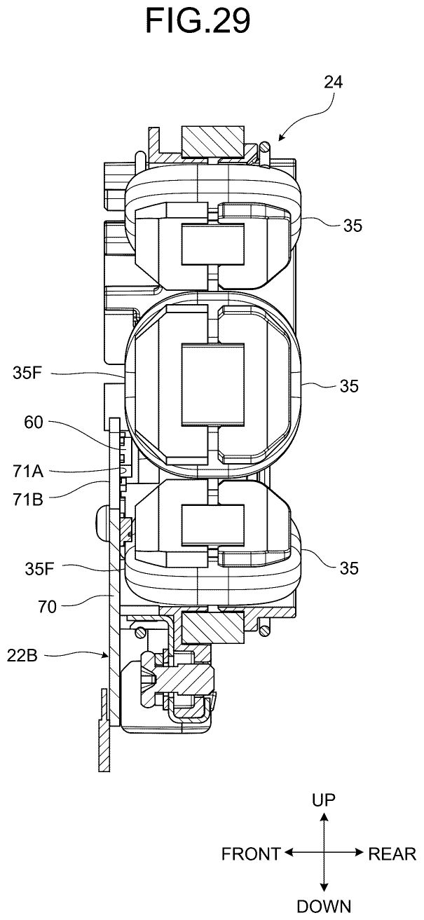

FIG. 27 is a front view of the stator 24 and the sensor substrate 22B according to the present embodiment. FIG. 28 is a left side view of the stator 24 and the sensor substrate 22B according to the present embodiment. FIG. 29 is a cross-sectional view of the stator 24 and the sensor substrate 22B according to the present embodiment.

The present embodiment is a modification of the second embodiment described above. In the second embodiment described above, each of the first surface 71A and the second surface 71B of the sensor substrate 22B is disposed at a position closer to the center of the coil 35 than the front end 35F of the coil 35. In other words, both the first surface 71A and the second surface 71B are disposed rearward of the front end 35F of the coil 35.

In the present embodiment, each of the first surface 71A and the second surface 71B of the sensor substrate 22B is disposed at a position farther from the center of the coil 35 than the front end 35F of the coil 35 is. In other words, both the first surface 71A and the second surface 71B are disposed forward of the front end 35F of the coil 35.

As described above, both the first surface 71A and the second surface 71B of the sensor substrate 22B may be disposed forward of the front end 35F of the coil 35.

### Seventh Embodiment

A seventh embodiment will be described. In the following description, the same or equivalent components as those of the above-describe embodiments are denoted by the same reference signs, and the description of the components is simplified or omitted.

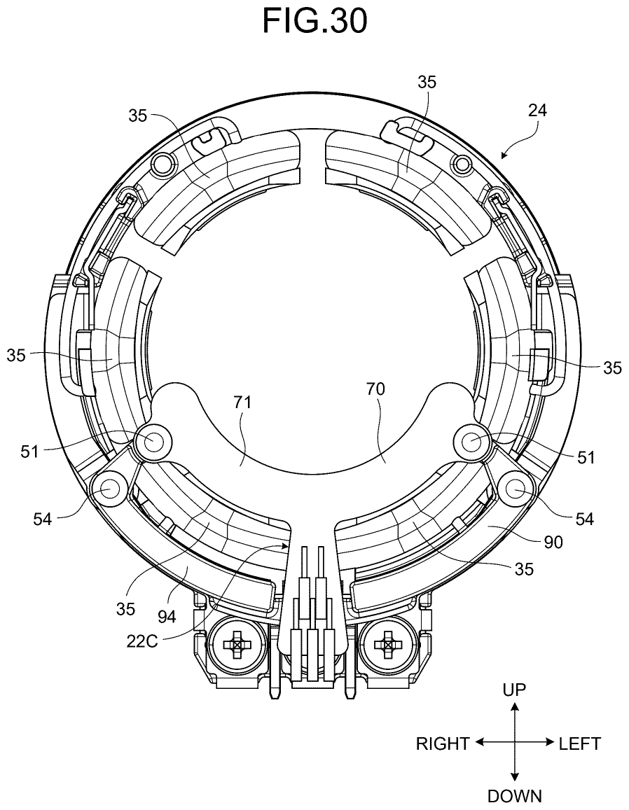

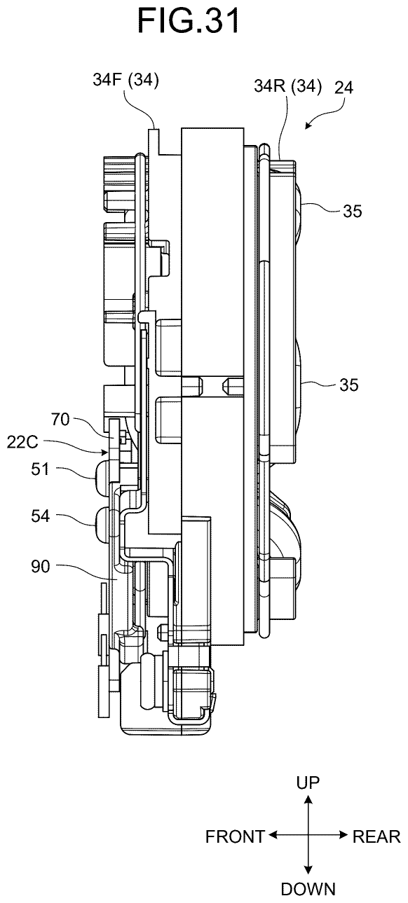

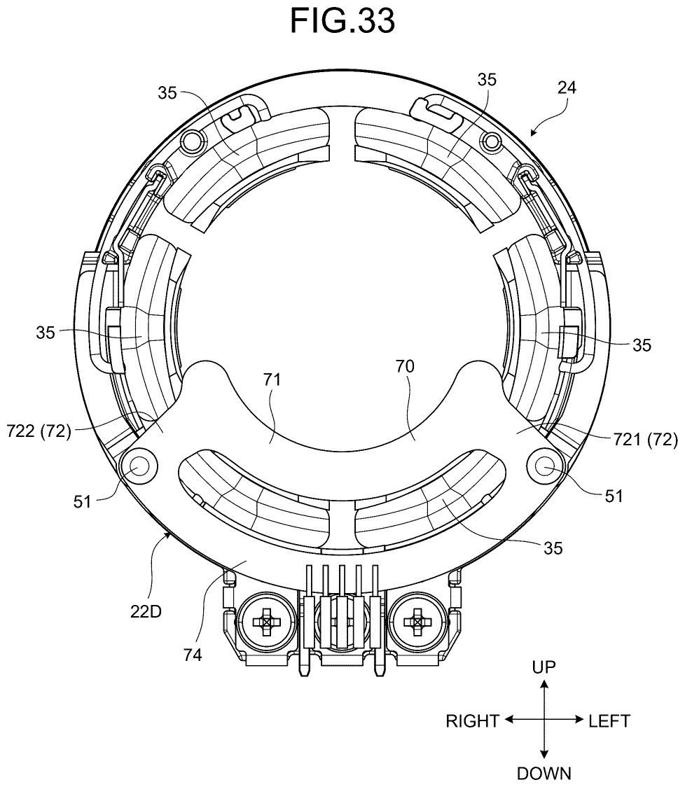

FIG. 30 is a front view of the stator 24 and the sensor substrate 22C according to the present embodiment. FIG. 31 is a left side view of the stator 24 and the sensor substrate 22C according to the present embodiment. FIG. 33 is a cross-sectional view illustrating the stator 24 and the sensor substrate 22C according to the present embodiment.

The present embodiment is a modification of the third embodiment described above. In the third embodiment described above, each of the first surface 71A and the second surface 71B of the sensor substrate 22C is disposed at a position closer to the center of the coil 35 than the front end 35F of the coil 35. In other words, both the first surface 71A and the second surface 71B are disposed rearward of the front end 35F of the coil 35.

In the present embodiment, each of the first surface 71A and the second surface 71B of the sensor substrate 22C is disposed at a position farther from the center of the coil 35 than the front end 35F of the coil 35 is. In other words, both the first surface 71A and the second surface 71B are disposed forward of the front end 35F of the coil 35.

As described above, both the first surface 71A and the second surface 71B of the sensor substrate 22C may be disposed forward of the front end 35F of the coil 35.

### Eighth Embodiment

An eighth embodiment will be described. In the following description, the same or equivalent components as those of the above-described embodiments are denoted by the same reference signs, and the description of the components is simplified or omitted.

FIG. 33 is a front view of the stator 24 and the sensor substrate 22D according to the present embodiment.

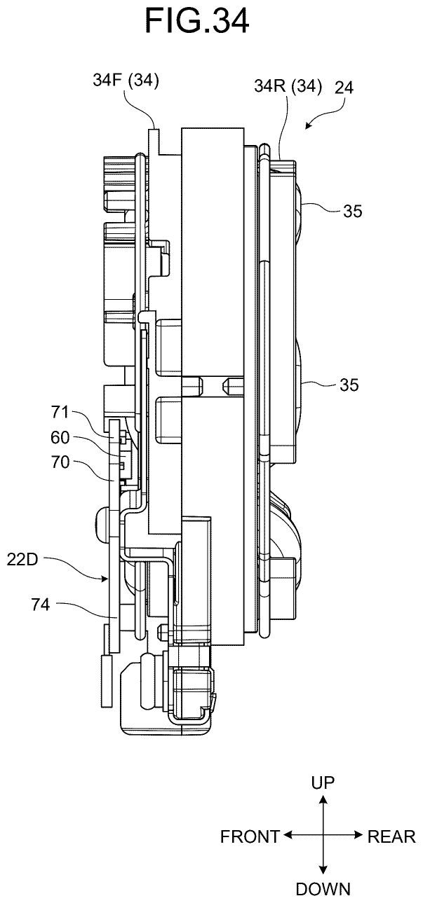

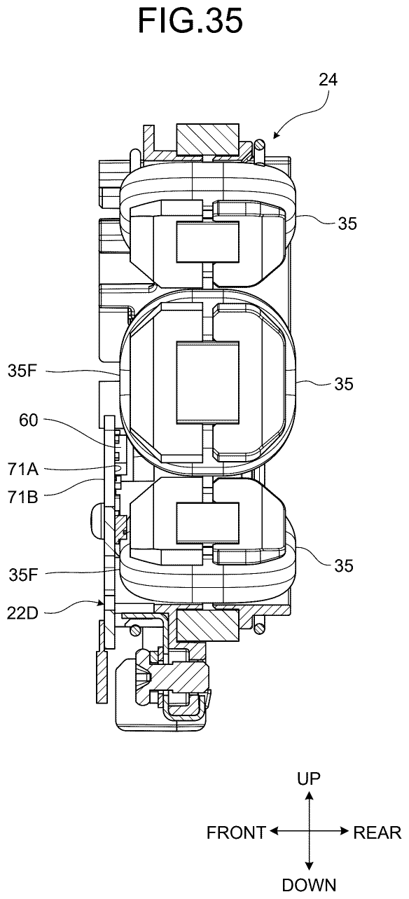

FIG. 34 is a left side view of the stator 24 and the sensor substrate 22D according to the present embodiment. FIG. 35 is a cross-sectional view of the stator 24 and the sensor substrate 22D according to the present embodiment.

The present embodiment is a modification of the fourth embodiment described above. In the above-described fourth embodiment, each of the first surface 71A and the second surface 71B of the sensor substrate 22D is disposed at a position closer to the center of the coil 35 than the front end 35F of the coil 35. In other words, both the first surface 71A and the second surface 71B are disposed rearward of the front end 35F of the coil 35.

In the present embodiment, each of the first surface 71A and the second surface 71B of the sensor substrate 22D is disposed at a position farther from the center of the coil 35 than the front end 35F of the coil 35 is. In other words, both the first surface 71A and the second surface 71B are disposed forward of the front end 35F of the coil 35.

As described above, both the first surface 71A and the second surface 71B of the sensor substrate 22D may be disposed forward of the front end 35F of the coil 35.

### Ninth Embodiment

A ninth embodiment will be described. In the following description, the same or equivalent components as those of the above-described embodiments are denoted by the same reference signs, and the description of the components is simplified or omitted.

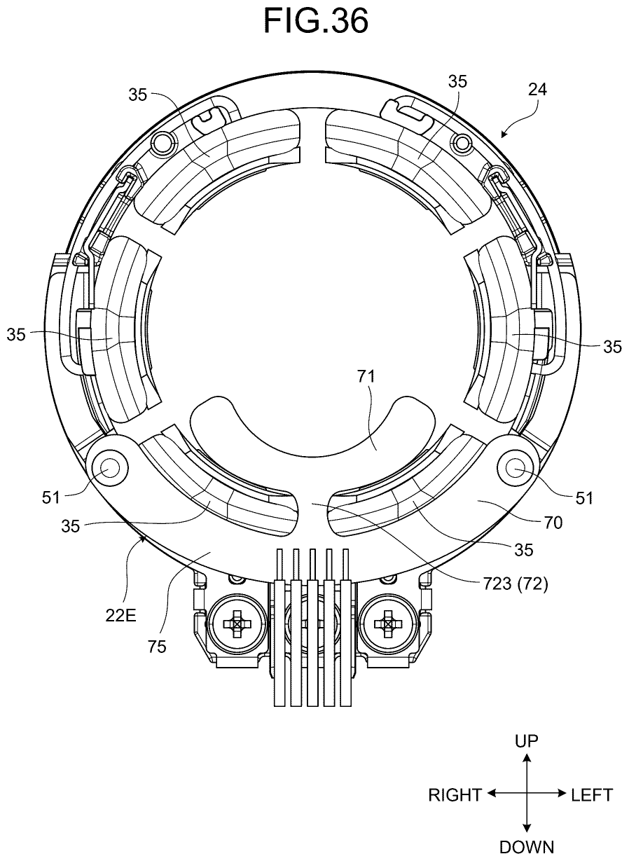

FIG. 36 is a front view of the stator 24 and a sensor substrate 22E according to the present embodiment. As illustrated in FIG. 36, the plate 70 of the sensor substrate 22E includes an arc portion 71, an arm portion 72, and an outer arc portion 75. In the present embodiment, the plate 70 includes, as the arm portion, the third arm portion 723 and does not include the first arm portion 721 and the second arm portion 722. The outer arc portion 75 is connected to the radially outer end of the third arm portion 723.

The outer arc portion 75 has an arc shape extending partially around the rotation axis AX. The outer arc portion 75 is disposed radially outside the coils 35. In a plane orthogonal to the rotation axis AX, the outer arc portion 75 is disposed so as to overlap the annular portion 48 of the front insulator 34F. Each of one end portion and the other end portion of the outer arc portion 75 in the circumferential direction is fixed to the front insulator 34F by the screws 51.

Assuming that the position of the upper end portion in the circumferential direction is a position of 0 degrees, the position of the left end portion in the circumferential direction is a position of 90 degrees, the position of the lower end portion in the circumferential direction is a position of 180 degrees, and the position of the right end portion in the circumferential direction is a position of 270 degrees; the outer arc portion 75 is disposed in a range of approximately 110 degrees to 250 degrees.

The outer arc portion 75 is disposed radially inside the power supply terminals 39. The signal lines 80 are supported on the front surface of the outer arc portion 75.

In the axial direction, the first surface 71A is disposed at a position closer to the center of the coil 35 than a front end 35F of the coil 35. In the axial direction, the second surface 71B is also disposed at a position closer to the center of the coil 35 than the front end 35F of the coil 35. In other words, both the first surface 71A and the second surface 71B are disposed rearward of the front end 35F of the coil 35. Alternatively, both the first surface 71A and the second surface 71B may be disposed forward of the front end 35F of the coil 35.

As described above, a single arm portion 72 may be provided.

### Tenth Embodiment

A tenth embodiment will be described. In the following description, the same or equivalent components as those of the above-described embodiments are denoted by the same reference signs, and the description of the components is simplified or omitted.

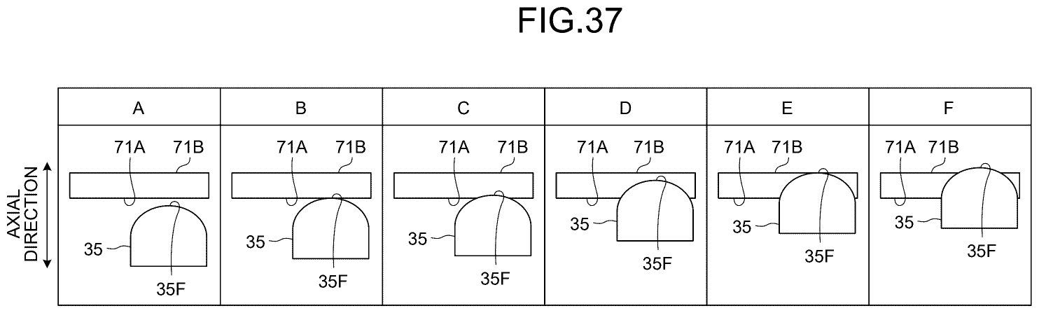

FIG. 37 is a diagram illustrating a relationship of the first surface 71A and the second surface 71B to the front end 35F of the coil 35 according to the embodiments.

In each of the first to ninth embodiments described above, as illustrated in a state A in FIG. 37, each of the first surface 71A and the second surface 71B may be disposed at a position farther from the center of the coil 35 than the front end 35F of the coil 35 in the axial direction is. In other words, both the first surface 71A and the second surface 71B may be disposed forward of the front end 35F of the coil 35.

In each of the first to ninth embodiments described above, as illustrated in a state B in FIG. 37, the position of the first surface 71A may coincide with the position of the front end 35F of the coil 35 in the axial direction, and the second surface 71B may be disposed forward of the front end 35F of the coil 35.

In each of the first to ninth embodiments described above, as illustrated in a state C in FIG. 37, in the axial direction, the first surface 71A may be disposed rearward of the front end 35F of the coil 35, and the second surface 71B may be disposed forward of the front end 35F of the coil 35. In the state C, the front end 35F of the coil 35 is disposed rearward of the center of the plate 70 in the axial direction.

In each of the first to ninth embodiments described above, as illustrated in a state D in FIG. 37, in the axial direction, the first surface 71A may be disposed rearward of the front end 35F of the coil 35, and the second surface 71B may be disposed forward of the front end 35F of the coil 35. In the state D, the front end 35F of the coil 35 is disposed forward of the center of the plate 70 in the axial direction.

In each of the first to ninth embodiments described above, as illustrated in a state E in FIG. 37, the first surface 71A may be disposed rearward of the front end 35F of the coil 35 in the axial direction, and the position of the second surface 71B may coincide with the position of the front end 35F of the coil 35.

In each of the first to ninth embodiments described above, as illustrated in a state F in FIG. 37, in the axial direction, each of the first surface 71A and the second surface 71B may be disposed at a position closer to the center of the coil 35 than the front end 35F of the coil 35. In other words, both the first surface 71A and the second surface 71B may be disposed rearward of the front end 35F of the coil 35.

### Other Embodiments

In the embodiments described above, the electric work machine 1 is a vibration driver drill that is a type of electric tool. The electric tool is not limited to the vibration driver drill. Examples of the electric tool include a driver drill, an angle drill, an impact driver, a grinder, a hammer, a hammer drill, a circular saw, and a reciprocating saw. Further, the electric work machine 1 may be an outdoor power equipment. Examples of the outdoor power equipment include a chain saw, a hedge trimmer, a lawn mower, a grass mower, and a blower.

In the above-described embodiments, the battery pack 19 attached to the battery mounting portion is used as the power source of the electric work machine. As a power source of the electric work machine, a commercial power source (AC power source) may be used.

### Eleventh Embodiment

An eleventh embodiment will be described. In the following description, the same or equivalent components as those of the above-described embodiments are denoted by the same reference signs, and the description of the components is simplified or omitted.

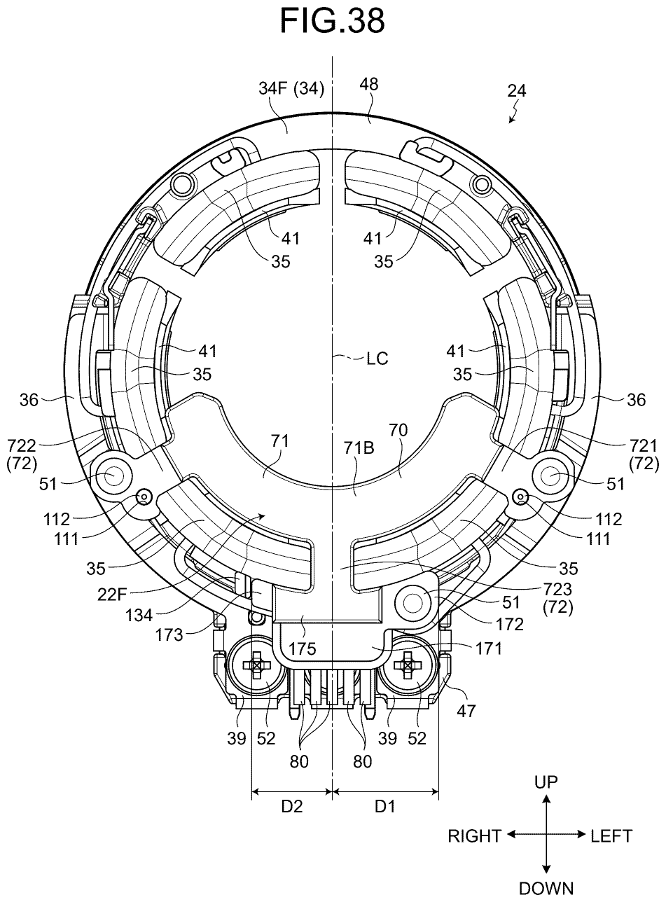

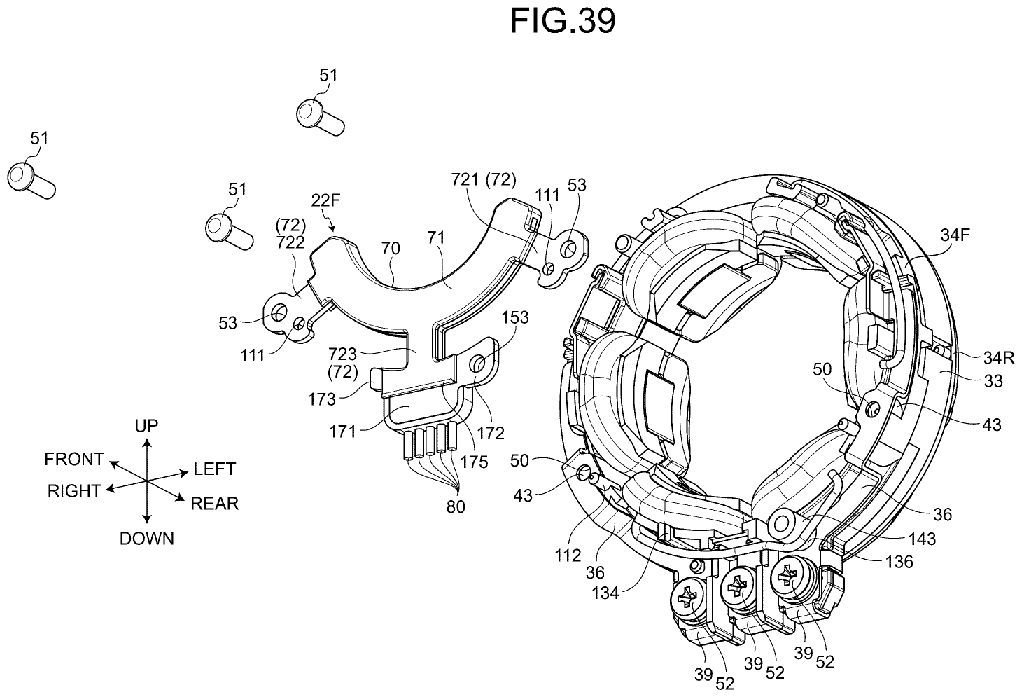

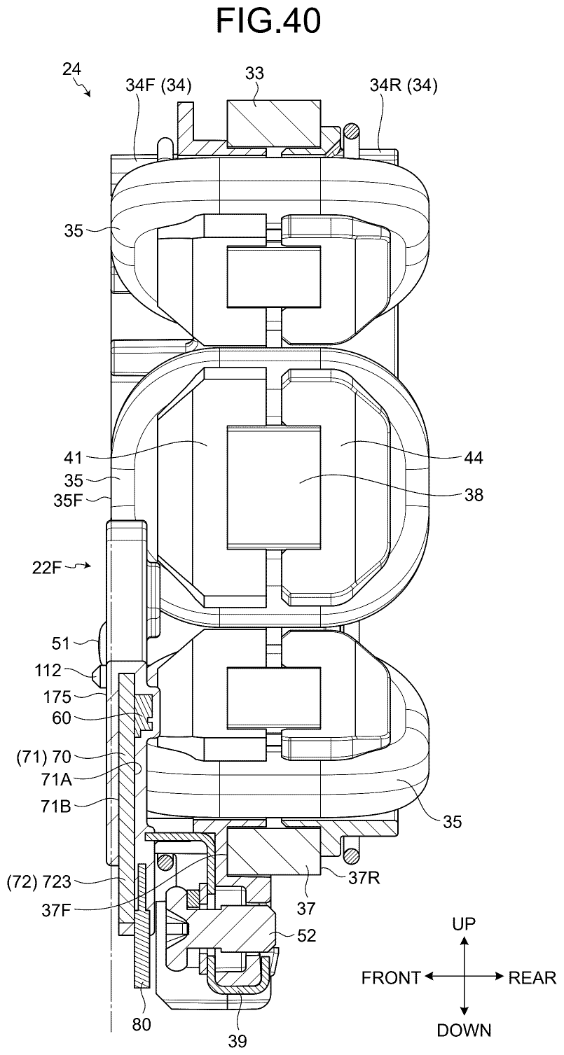

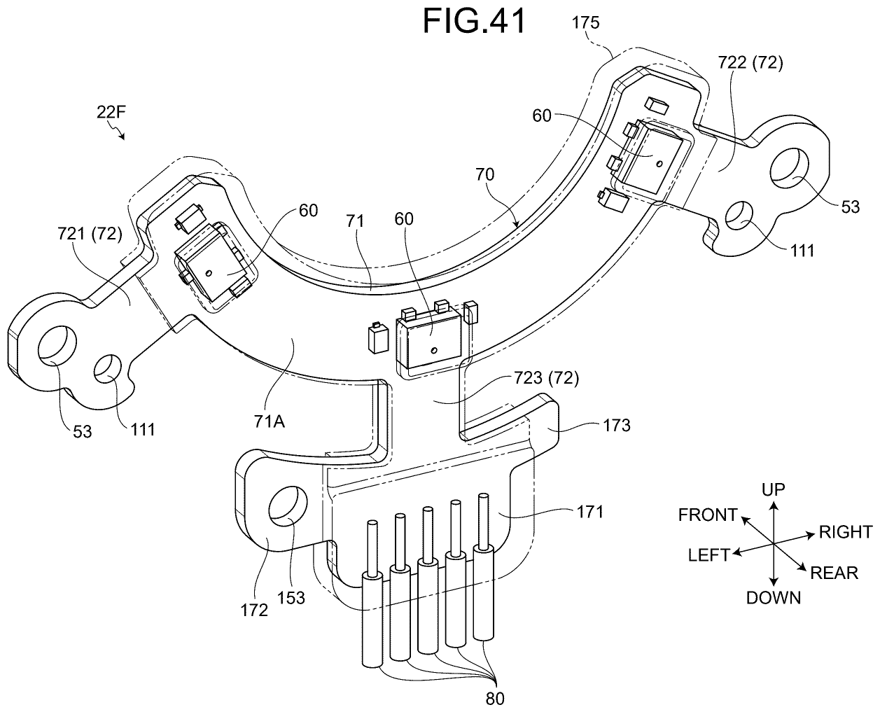

FIG. 38 is a front view of a stator and a sensor substrate according to the eleventh embodiment. FIG. 39 is an exploded front perspective view of the stator and the sensor substrate according to the eleventh embodiment. FIG. 40 is a cross-sectional view of the stator and the sensor substrate according to the eleventh embodiment. FIG. 41 is a perspective view of a portion covered with a cover of the sensor substrate according to the eleventh embodiment.

### Fixation of Arm Portion

When any one of the first arm portion 721, the second arm portion 722, and the third arm portion 723 has a free end that is not fixed, vibration is likely to occur in the arm portion with the free end due to vibration during the use of the electric work machine 1. Therefore, in the eleventh embodiment, radially outer ends of the arm portions 72 of the plate 70 are fixed. Specifically, the plate 70 includes three arm portions 72 that are the first arm portion 721, the second arm portion 722, and the third arm portion 723. The first arm portion 721, the second arm portion 722, and the third arm portion 723 are fixed to the front insulator 34F. The first arm portion 721, the second arm portion 722, and the third arm portion 723 are fixed to the front insulator 34F by screws 51.

Screw openings 53 are provided at the radially outer ends of the first arm portion 721 and the second arm portion 722, respectively. The screws 51 are inserted into the screw openings 53 and the screw openings 50 provided in the short-circuiting members 36, and then inserted into the screw holes of the screw bosses 43 of the front insulator 34F.

A screw opening 153 is provided on the radially outer end of the third arm portion 723. The screw 51 is inserted into the screw opening 153 and then inserted into a screw hole of a screw boss 143 of the front insulator 34F. The screw boss 143 has a cylindrical shape, and the screw hole is formed in a tip surface thereof. One of the short-circuiting members 36 has a notch 136 for passing the screw boss 143, instead of being provided with a screw opening 50 for the screw boss 143. The screw boss 143 extends toward the front side of the short-circuiting member 36 through inside of the notch 136. The third arm portion 723 is directly fixed to the screw boss 143 of the front insulator 34F without interposing the short-circuiting member 36.

The screw 51 may be a normal screw of a type coupled to a screw hole in which a screw groove (female thread) is formed in advance, or may be a tapping screw. The tapping screw is a screw of a type in which a screw groove (female thread) is formed by the screw itself by being screwed into a pilot hole in which no female thread is formed.

### Positioning

In position detection of the rotor 23 by the rotation sensors 60, it is important to reduce position variations due to an assembly error of the rotation sensors 60 in order to secure detection accuracy. Therefore, in the eleventh embodiment, the stator 24 and a sensor substrate 22F have a positioning structure of the sensor substrate 22F with respect to the stator 24. Specifically, positioning holes 111 are formed in the sensor substrate 22F, and positioning pins 112 are provided in the front insulator 34F.

The sensor substrate 22F has the positioning

holes 111. The positioning holes 111 are disposed on ends of the sensor substrate 22F in the circumferential direction. The positioning holes 111 are respectively provided at the radially outer ends of the first arm portion 721 and the second arm portion 722. The positioning holes 111 are disposed near the screw openings 53. Each of the positioning holes 111 has a circular shape and penetrates the plate 70 in the thickness direction.

The front insulator 34F has the same number of (i.e., two) positioning pins 112 as the number of positioning holes 111 of the sensor substrate 22F. The positioning pins 112 may be integrated with the front insulator 34F or may be separate from the front insulator 34F. The two positioning pins 112 are disposed at positions overlapping with the positioning holes 111 of the sensor substrate 22F in a plane orthogonal to the rotation axis AX. Each of the positioning pins 112 protrudes forward from the front surface of the front insulator 34F facing the sensor substrate 22F. Each of the positioning pins 112 has a cylindrical shape. When the sensor substrate 22F is fixed to the front insulator 34F, the positioning pins 112 are inserted into the respective positioning holes 111. As a result, the sensor substrate 22F is positioned with respect to the stator 24 via the front insulator 34F, and positional variations of the rotation sensor 60 due to the assembly error are suppressed.

### Reverse Attachment Prevention Structure

When the sensor substrate 22F is attached to the stator 24, an operator may erroneously attach the sensor substrate 22F with the front and rear being reversed. In the eleventh embodiment, the stator 24 and the sensor substrate 22F have a structure capable of preventing the sensor substrate 22F from being erroneously attached to the stator 24 such that the front and rear of the sensor substrate 22F are reversed. Specifically, the sensor substrate 22F has an asymmetric structure with respect to a center line LC as illustrated in FIG. 38. The center line LC is a line passing through the center in the left-right direction in a plane of the sensor substrate 22F.

The sensor substrate 22F is fixed at each end of the first arm portion 721, the second arm portion 722, and the third arm portion 723. The first arm portion 721 and the second arm portion 722 are symmetric with respect to the center line LC. The screw opening 53 and the positioning hole 111 of the first arm portion 721 and the screw opening 53 and the positioning hole 111 of the second arm portion 722 are symmetrical with respect to the center line LC.

On the other hand, the third arm portion 723 is asymmetric with respect to the center line LC. The end of the third arm portion 723 has a central portion 171 along the center line LC, a one-side protruding portion 172 projecting from the central portion 171 to one side (left side), and an other-side protruding portion 173 projecting from the central portion 171 to the other side (right side). The one-side protruding portion 172 and the other-side protruding portion 173 are formed at the same position in a direction along the center line LC (an up-down direction). The one-side protruding portion 172 and the other-side protruding portion 173 protrude from the central portion 171 in directions opposite to each other. The third arm portion 723 has the asymmetric shape with respect to the center line LC at the one-side protruding portion 172 and the other-side protruding portion 173.

Specifically, a distance D1 from the center line LC to a tip of the one-side protruding portion 172 is different from a distance D2 from the center line LC to a tip of the other-side protruding portion 173. The distance D1 is larger than the distance D2. The one-side protruding portion 172 is larger than the other-side protruding portion 173. The screw opening 153 is formed in the one-side protruding portion 172. The screw opening 153 is formed on the end portion of the third arm portion 723 at a position deviated to left or right of the center (center line LC).

The front insulator 34F includes a guide rib 134 for preventing the sensor substrate 22F from being erroneously attached such that the front and rear are reversed. The guide rib 134 protrudes forward from the front surface of the front insulator 34F. The guide rib 134 is disposed on the other side (right side) with respect to the center line LC. The guide rib 134 is disposed at a position adjacent to the tip of the other-side protrusion 173. The guide rib 134 faces the other-side protrusion 173 in the left-right direction. The guide rib 134 is disposed at a position where a distance from the center line LC is smaller than the distance D1 and larger than the distance D2. As a result, the guide rib 134 is disposed at a position such that the guide rib 134 makes contact with the one-side protrusion 172 when the front and rear of the sensor substrate 22F are reversed.

In FIG. 38, when the front and rear of the sensor substrate 22F are reversed, the one-side protrusion 172 of the third arm portion 723 is arranged on the other side (right side) with respect to the center line LC, and the other-side protrusion 173 is arranged on the one side (left side) with respect to the center line LC. In this case, since the one-side protrusion 172 is disposed on the guide rib 134 and the sensor substrate 22F is tilted, the sensor substrate 22F cannot be disposed in a normal attitude. In addition, the position of the screw opening 153 of the one-side protrusion 172 does not coincide with the position of the screw boss 143. Therefore, an operator who performs assembly can recognize that the sensor substrate 22F is not properly arranged.

### Cover

In the eleventh embodiment, the sensor substrate 22F has a cover 175 that covers the rotation sensors 60 and end portions of the signal lines 80 (portions connected to the sensor substrate 22F). The cover 175 is made of resin and formed on the plate 70 by a molding method. The cover 175 wraps and seals the rotation sensors 60 and the end portions of the signal lines 80. In FIG. 41, for convenience of explanation, an outer shape of the cover 175 is indicated by a two-dot chain line, and each component covered by the cover 175 is illustrated by a solid line.

The rotation sensors 60 are disposed on the first surface 71A, which faces the end surface 27F of the rotor 23, of the arc portion 71 of the plate 70. The end portions of the signal lines 80 are disposed between the plate 70 and the stator core 33. The end portions of the signal lines 80 are disposed on the same surface (first surface 71A) of the plate 70 as the rotation sensors 60. In other words, the end portions of the signal lines 80 are disposed on the surface facing the stator core 33 at the end of the third arm portion 723. The end portions of the signal lines 80 are connected to a circuit of the sensor substrate 22F at the central portion 171 of the third arm portion 723.

The cover 175 covers a circuit forming portion of the plate 70. The cover 175 covers the arc portion 71 where the rotation sensors 60 are disposed. The cover 175 covers both the first surface 71A and the second surface 71B of the arc portion 71. As illustrated in FIG. 40, each of the first surface 71A and the second surface 71B is disposed rearward of the front end 35F of the coil 35 and closer to the center of the coil 35 than the front end 35F of the coil 35. The cover 175 covers the central portion 171 of the third arm portion 723 of the plate 70.

The cover 175 is not formed on contact portions of the plate 70 where the plate 70 makes contact with the front insulator 34F and the short-circuiting members 36. The cover 175 does not cover and exposes the end portion of the first arm portion 721 and the end portion of the second arm portion 722 of the plate 70. The cover 175 does not cover and exposes the one-side protrusion 172 and the other-side protrusion 173 of the third arm portion 723. Since the cover 175 is not provided on the contact portions, positional displacement of the sensor substrate 22F due to a dimensional error of the cover 175 is prevented when the sensor substrate 22F is fixed.

As described above, in the present embodiment, the radially outer ends of the arm portions 72 of the plate 70 are fixed to the insulator 34.

In the above configuration, since the arm portions 72 do not have free ends, vibration of the sensor substrate 22F is suppressed.

In the present embodiment, the screw opening 153 of the third arm portion 723 is provided in the one-side protrusion 172, but the screw opening 153 may be provided in the other-side protrusion 173, or the screw opening 153 may be provided in the central portion 171.

In the present embodiment, the stator 24 and the sensor substrate 22F have a structure for positioning the sensor substrate 22F with respect to the stator 24.

In the above configuration, since the positional variation of the rotation sensors 60 due to the assembly error of the sensor substrate 22F can be reduced, the detection accuracy of the rotation sensors 60 can be secured.

The positioning pins 112 may be formed on the sensor substrate 22F, and the positioning holes 111 may be provided in the front insulator 34F. In other words, the positioning holes 111 may be provided in one of the sensor substrate 22F and the insulator 34, and the positioning pins 112 fitted to the positioning holes 111 may be provided in the other of the sensor substrate 22F and the insulator 34.

In the present embodiment, the stator 24 and the sensor substrate 22F have a structure capable of preventing the sensor substrate 22F from being erroneously attached to the stator 24 such that the front and rear of the sensor substrate 22F are reversed.

In the above configuration, when the sensor substrate 22F is attached to the stator 24, it is possible to prevent the sensor substrate 22F from being erroneously attached to the stator 24 such that the front and rear are reversed. Since the operator does not need to pay attention to the front and rear of the sensor substrate 22F, attachment workability is improved.

A structure for preventing erroneous attachment of the sensor substrate 22F is not limited to the above-described embodiment. For example, the positioning pin 112 disposed in the positioning hole 111 of the first arm portion 721 and the positioning pin 112 disposed in the positioning hole 111 of the second arm portion 722 may have different shapes and/or positions. Examples of the different shapes include different diameters of the positioning pins 112 and different outer shapes. Due to the difference in shape, the positioning pin 112 of one of the arm portions 72 is not inserted into the positioning hole 111 of another arm portion 72. Alternatively, the positions of the positioning pins 112 as well as their respective positioning holes 111 may be made asymmetric with respect to the center line LC. In this case, the positions of the positioning holes 111 and the positions of the positioning pins 112 do not coincide with each other when the front and rear of the sensor substrate 22F are reversed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electric work machine comprising:
a motor including a rotor that rotates about a rotation axis and a stator disposed around the rotor; and
a sensor substrate including a rotation sensor that detects rotation of the rotor and a plate that supports the rotation sensor, wherein
the stator includes
a stator core disposed around the rotor,
an insulator fixed to the stator core, and
a plurality of coils fixed to the insulator and arranged at intervals in a circumferential direction, the plate includes
an arc portion extending partially around the rotation axis and having a first surface facing an end surface of the rotor in an axial direction, and
at least two arm portions protruding outward in a radial direction from the arc portion and fixed to the insulator, and
the rotation sensor is disposed on the first surface.

2. The electric work machine according to claim 1, wherein
the arc portion is disposed radially inside the coil.

3. The electric work machine according to claim 2, wherein
a radially outer end of the arm portion is disposed radially outside the coil, and
the radially outer end of the arm portion is fixed to the insulator.

4. The electric work machine according to claim 2, wherein
in the axial direction, the first surface is disposed at a position closer to a center of the coil than one end of the coil.

5. The electric work machine according to claim 4, wherein
the arc portion has a second surface facing in a direction opposite to a direction in which the first surface faces, and
in the axial direction, the second surface is disposed at a position closer to the center of the coil than the one end of the coil.

6. The electric work machine according to claim 5, wherein
the plate is a parallel flat plate.

7. The electric work machine according to claim 6, wherein
each of the arm portions is disposed between a pair of the coils adjacent to each other.

8. The electric work machine according to claim 7, wherein
the arm portions include a first arm portion and a second arm portion,
the first arm portion protrudes outward in the radial direction from one end of the arc portion in the circumferential direction, and
the second arm portion protrudes outward in the radial direction from other end of the arc portion in the circumferential direction.

9. The electric work machine according to claim 8, wherein
the plate includes
a bridge portion that connects a radially outer end of the first arm portion and a radially outer end of the second arm portion.

10. The electric work machine according to claim 9, wherein
the bridge portion has an arc shape extending partially around the rotation axis.

11. The electric work machine according to claim 9, further comprising:
a controller configured to control a drive current supplied to the coils based on a detection signal of the rotation sensor; and
a signal line configured to connect the rotation sensor and the controller, wherein the signal line is supported by the bridge portion.

12. The electric work machine according to claim 8, wherein
the arm portions include a third arm portion, and
the third arm portion protrudes outward in the radial direction from a center of the arc portion in the circumferential direction.

13. The electric work machine according to claim 12, further comprising:
a controller configured to control a drive current supplied to the coils based on a detection signal of the rotation sensor; and
a signal line configured to connect the rotation sensor and the controller, wherein the signal line is supported by the third arm portion.

14. The electric work machine according to claim 13, further comprising a power supply terminal through which the drive current flows, wherein
the third arm portion is disposed so as to overlap with the power supply terminal in a plane orthogonal to the rotation axis.

15. The electric work machine according to claim 12, wherein
at least one of the first arm portion, the second arm portion, and the third arm portion is fixed to the insulator by a screw.

16. The electric work machine according to claim 12, wherein
the plate includes
a cover portion that connects a radially outer end of the first arm portion, a radially outer end of the second arm portion, and a radially outer end of the third arm portion.

17. The electric work machine according to claim 16, further comprising:
a controller configured to control a drive current supplied to the coils based on a detection signal of the rotation sensor; and
a signal line configured to connect the rotation sensor and the controller, wherein
the signal line is supported on the cover portion.

18. The electric work machine according to claim 17, further comprising a power supply terminal through which the drive current flows, wherein
the cover portion is disposed so as to overlap with the power supply terminal in a plane orthogonal to the rotation axis.

19. The electric work machine according to claim 1, further comprising a support member fixed to the insulator, wherein
the at least two arm portions are fixed to the insulator via the support member.

20. The electric work machine according to claim 19, wherein
the support member includes
a support arc portion fixed to the insulator by a first screw, and
a screw boss, which is disposed radially inside the support arc portion and to which the arm portion is fixed by a second screw,
the screw boss has an end surface facing in a same direction as the first surface in the axial direction, and
the end surface of the screw boss is disposed at a position closer to a center of the coil than an end surface of the stator core facing in a direction opposite to the direction in which the first surface faces.
